(19) United States
(12) Patent Application Publication
(10) Pub. No.: US 2025/0378036 A1
(43) Pub. Date: Dec. 11, 2025

(54) MACHINE LEARNING ACCELERATION ARCHITECTURE

(71) Applicant: Synaptics Incorporated, San Jose, CA (US)

(72) Inventors: Deepak Mital, Fremont, CA (US); Hongjie Guan, Newark, CA (US)

(73) Assignee: Synaptics Incorporated, San Jose, CA (US)

(21) Appl. No.: 19/208,410

(22) Filed: May 14, 2025

Related U.S. Application Data
(60) Provisional application No. 63/658,740, filed on Jun. 11, 2024.

(51) Int. Cl. G06F 13/28

(52) U.S. Cl. CPC G06F 13/28; G06F 2213/28

(57) ABSTRACT

A machine learning accelerator includes a scalable processor with a plurality of cores that receive data from system memory via a system direct memory access (DMA) engine. Each core may include local memory, a compute sub-system, and one or more slices, each of which includes a descriptor execution engine and one or more compute engines. Each compute engine includes input data memory, one or more sub-compute engines, and partial data memory. The sub-compute engines are separately connected to the input data memory and are configured to independently perform compute operations, such as multiply-accumulate (MAC) operations, on the input data and to provide partial output data to the partial data memory. The cores, slices and sub-compute engines may be configured to operate independently to perform separate tasks in parallel that once completed are combined as part of a large artificial intelligence model.

### CLAIM OF PRIORITY

This application claims the benefit of and priority to U.S. Provisional Application No. 63/658,740, filed Jun. 11, 2024, and entitled “MACHINE LEARNING ACCELERATION ARCHITECTURE,” which is assigned to the assignee hereof and is incorporated herein by reference in its entirety.

### TECHNICAL FIELD

The present disclosure relates to data processing techniques and hardware and, more particularly, to a data processing system for machine learning applications.

### BACKGROUND OF RELATED ART

Machine learning (ML) is a field within artificial intelligence in which statistical algorithms are used to learn from data, which can then be generalized to unseen data. Machine learning algorithms, for example, are applied in many applications, such as natural language processing, speech recognition, email filtering, audio/video recognition, video summarization, etc. The workloads for performing machine learning operations are conventionally performed using hardware platforms, such as central processing units (CPUs) or graphics processing units (GPUs). The use of CPUs is preferable for general tasks that are to be performed in a fast, sequential manner. GPUs, on the other hand, use parallel processing and can separate complex problems into multiple smaller calculations that can be performed simultaneously. For massively distributed computational processes as required for machine learning, GPUs are the current state of the art. Unfortunately, GPUs are not efficient in power consumption or in terms of size and cost. Accordingly, an improved platform for implementing machine learning algorithms is desirable.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

As described herein, a machine learning accelerator includes a scalable processor that is fully programmable to implement various operations and accommodate different shapes and formats of input data. The machine learning accelerator may include a plurality of cores that receive data from system memory via a system direct memory access (DMA) engine. Each core may include local memory, a compute sub-system, and one or more slices, each of which includes a descriptor execution engine and one or more compute engines. Each compute engine includes input data memory, one or more sub-compute engines, and partial data memory. The input data memory within each compute engine leads to high compute efficiency and reduces power requirements. The sub-compute engines are separately communicatively coupled to the input data memory and are configured to independently perform compute operations, such as multiply-accumulate (MAC) operations, on the input data and to provide partial output data to the partial data memory. The cores, slices and sub-compute engines may be configured to operate independently to perform separate tasks in parallel that, once completed, are combined as part of a large artificial intelligence model.

One aspect of the subject matter of this disclosure is implemented in an apparatus that is configured for machine learning acceleration and includes a system direct memory access (DMA) engine that is communicatively coupled to a system memory. The apparatus includes at least one core that is communicatively coupled to the system DMA engine via an interconnect. The system DMA engine is configured to transfer data to local memory in the at least one core via the interconnect. A core includes one or more slices, each of which includes a compute engine. Each compute engine includes input data memory, one or more sub-compute engines, and partial data memory. The input data memory is communicatively coupled to receive the data from the local memory and each sub-compute engine is separately communicatively coupled to the input data memory and is configured to perform a compute operation on the input data stored in the input data memory. The partial data memory is communicatively coupled to receive and store a compute output from each of the one or more sub-compute engines.

One aspect of the subject matter of this disclosure is implemented in a method for performing machine learning acceleration, which includes transferring data with a system direct memory access (DMA) engine from a system memory to local memory in at least one core via an interconnect. A core includes one or more slices, and each slice includes a compute engine. The method further includes transferring the data from the local memory to an input memory in the compute engine of each slice and transferring the data from the input memory to one or more sub-compute engines, where each sub-compute engine is independent of other sub-compute engines. The method further includes performing independent compute operations on the data by each sub-compute engine, and receiving and storing in partial data memory in the compute engine a compute output from each of the one or more sub-compute engines.

One aspect of the subject matter of this disclosure is implemented in an apparatus that is configured for machine learning acceleration and includes a system direct memory access (DMA) engine communicatively coupled to a system memory. The apparatus includes at least one core communicatively coupled to the system DMA engine via an interconnect. Each core includes a local memory configured to receive data transferred via the system DMA engine and includes one or more compute engines. Each compute engine includes input data memory communicatively coupled to receive and store input data and weights from the local memory via an input data bus and a weights bus, and a plurality of sub-compute engines. Each sub-compute engine is separately communicatively coupled to the input data memory and is configured to perform a compute operation based on the input data and weights stored in the input data memory.

On aspect of the subject matter of this disclosure is implemented in an apparatus that is configured for machine learning acceleration and includes a system direct memory access (DMA) engine communicatively coupled to a system memory. The apparatus includes at least one core communicatively coupled to the system DMA engine via an interconnect and includes one or more compute engines. The system DMA engine is configured to transfer data to the at least one core via the interconnect. Each compute engine includes a plurality of sub-compute engines that is independent of the other sub-compute engines. The data transferred by the system DMA engine is divided into common data to be shared by all of the sub-compute engines and separate data and each sub-compute engine is configured to independently perform a compute operation using the common data and a different portion of the separate data.

One aspect of the subject matter of this disclosure is implemented in a method for performing machine learning acceleration, which includes transferring data with a system direct memory access (DMA) engine from a system memory to at least one core via an interconnect. A core includes one or more compute engines. The method may further include transferring the data to each compute engine in the one or more compute engines, each compute engine includes a plurality of sub-compute engines. Each sub-compute engine is independent of other sub-compute engines. The data is divided into common data to be shared by all of the sub-compute engines and separate data. The method may further include independently performing compute operations by each sub-compute engine using the common data and a different portion of the separate data.

### BRIEF DESCRIPTION OF THE DRAWINGS

The present implementations are illustrated by way of example and are not intended to be limited by the figures of the accompanying drawings.

FIG. 1 shows a block diagram of an example computing system configured for machine learning acceleration.

FIGS. 2A-2C are block diagrams illustrating the architecture of a machine learning acceleration system, according to some implementations.

FIG. 2A illustrates the top level of the architecture hardware for the machine learning acceleration system, according to some implementations.

FIG. 2B illustrates the compute engine implemented in the machine learning acceleration system, according to some implementations.

FIG. 2C illustrates a data flow through a portion of the machine learning acceleration system, according to some implementation.

FIG. 2D illustrates a compute sub-system implemented in the machine learning acceleration system, according to some implementations.

FIG. 2E shows an illustrative flow chart depicting operators running on the compute sub-system in double buffer mode, according to some implementations.

FIGS. 3A-3C are block diagrams illustrating the architecture of a machine learning acceleration system, according to another implementation.

FIG. 4 schematically illustrates an organization of registers and descriptors used in a machine learning acceleration system for basic data transfer functionality between the system memory, according to some implementations.

FIG. 5 schematically illustrates data stored in local memory that may be used to implement basic data transfer functionality between the local memory and the compute engines within each core.

FIG. 6 illustrates example masks that may be used by a compute engine.

FIG. 7 illustrates a 3×3 kernel and 3×3 data frame.

FIG. 8 illustrates the data flow within a compute engine for a 64Bx4ch input data, according to some implementations.

FIG. 9 illustrates a compute engine with sizes for the input data bus, output data bus, weights bus, and storages in the input data memory and partial data memory, and the size of the sub-compute engine, according to some implementations.

FIG. 10 illustrates the operation of a number of activation functions performed by a descriptor execution engine, according to some implementations.

FIG. 11 illustrates a diagram depicting a fully connected layer operation in the matching learning acceleration system, according to some implementations.

FIG. 12 illustrates a diagram depicting a matrix multiplication operation in the matching learning acceleration system, according to some implementations.

FIG. 13 illustrates a diagram depicting another matrix multiplication operation in the matching learning acceleration system, according to some implementations.

FIG. 14 illustrates a diagram depicting block quantization for weights which may be used with the machine learning acceleration system, according to some implementations.

FIG. 15 illustrates input data with which a convolution operation may be performed with a stride of two or four in the matching learning acceleration system, according to some implementations.

FIG. 16 shows an illustrative flowchart depicting an example operation for performing machine learning acceleration, according to some implementations.

FIG. 17 shows an illustrative flowchart depicting another example operation for performing machine learning acceleration, according to some implementations.

### DETAILED DESCRIPTION

In the following description, numerous specific details are set forth such as examples of specific components, circuits, and processes to provide a thorough understanding of the present disclosure. In the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory and the like.

As discussed herein, machine learning operations are typically performed using hardware platforms, such as central processing units (CPUs) or graphics processing units (GPUs). In general, the current state of the art is the use of GPUs, which use parallel processing and can separate complex problems into multiple smaller calculations that can be performed simultaneously. While GPUs may be used for implementing machine learning algorithms because they may achieve high programmability, GPUs are not specifically designed for such operations. For example, in conventional hardware platforms performing machine learning operations, one of the difficulties is the need for a significant amount of computation in the form of multiply-accumulate (MAC) operations, where the data that is fed into the MAC operations changes shapes and is three-dimensional (3D) or four dimensional (4D) matrices. The ability to feed variable shapes of matrices while efficiently utilizing all computations is desirable, but generally is lacking in conventional hardware platforms, such as GPUs. In general, GPUs are not efficient in power consumption or size and cost. Moreover, while other approaches of machine learning acceleration are available, such as the use of CPUs, these approaches are not scalable.

Various aspects as described herein relate to a scalable machine learning accelerator architecture that can be instantiated in silicon as pre-designed, reusable building blocks or modules. The machine learning accelerator architecture includes a scalable processor that is fully programable and therefore may be used to accelerate any desired artificial intelligence (AI) applications, such as accelerating image, video, audio, and transformer models and the like. The hardware of the machine learning accelerator is designed to efficiently process various machine learning operations and is designed to scale from low performance (less compute and hardware area) to high performance (larger compute) while maintaining high efficiency. For example, the machine learning accelerator may scale from 3.2 giga-operations per second (GOPS) to 64 or more tera-operations per second (TOPS) via a combination of instantiated compute and operating frequency. Moreover, the machine learning accelerator is fully programmable via descriptors to implement various machine learning operations.

The building blocks or modules of the machine learning accelerator, as discussed herein, include instantiated compute units, sometimes quantified as a number of MAC (multiply-accumulate) operators, but may be other computational operators. Additionally, the building blocks or modules of the machine learning accelerator include general purpose compute (GP Compute), which may be instantiated as a general-purpose embedded compute core such as an ARM M class microprocessor or RISC-V microprocessor or the like. The general purpose compute, for example, may be used to efficiently run operators that cannot be run via the instantiated compute. Additionally, internal memory (sometimes referred to as local memory or local RAM) may be instantiated as memory embedded with the modules and serves as a central memory for all the compute operators. The local memory may not be designed as hardware cache but may serve as a “buffer.” The size of local memory is scalable and may be selected at the time of designing the modules. A system memory, which in some, but not necessarily all, implementations, may be external to system instantiated in silicon, may serve as the main memory for the machine learning accelerator. The system memory, for example, may store the compiled model, instructions/descriptors, input/output data and any intermediate data if needed. In some configurations, the local memory itself may be used as the system memory. A host processor may be used as the main processor for the machine learning accelerator, which may be located within the system instantiated in silicon or may be external. The host processor, for example, may control the running or operation of the modules, and may have access to the system memory and local memory. The host processor, for example, may be used to ensure that the compute operators within the modules of the machine learning accelerator are used to their maximum capabilities. Additionally, the machine learning accelerator may use an “offline” compiler methodology, e.g., the compiler may analyze the model to be accelerated and may “shape” the model, ahead of runtime, so that it can be run efficiently on the machine learning accelerator. The compiler, for example, may generate the shaped model, instructions/descriptors for hardware, binary for the GP compute, and host code to accelerate the model.

The machine learning accelerator architecture as discussed herein enables variable shaped matrices to be fed to the compute operators, e.g., MAC operators, while keeping the processor architecture scalable for desired compute needs and is fully programmable. As used herein, “compute” refers to the manipulation of information or any type of calculation, e.g., involving arithmetical and non-arithmetical steps, or the operator units used therefor. The machine learning accelerator architecture, for example, includes input data memory, e.g., random access memory (RAM), that is physically located close to the compute engines and is used without pre-fetching the data from large RAM, which improves efficiency and reduces power requirements. Similarly, in some implementations, cores are communicatively coupled via an interconnect, such as a core ring, leading to further improving efficiency. Moreover, the sub-compute engines are scalable thereby improving the efficiency of the hardware.

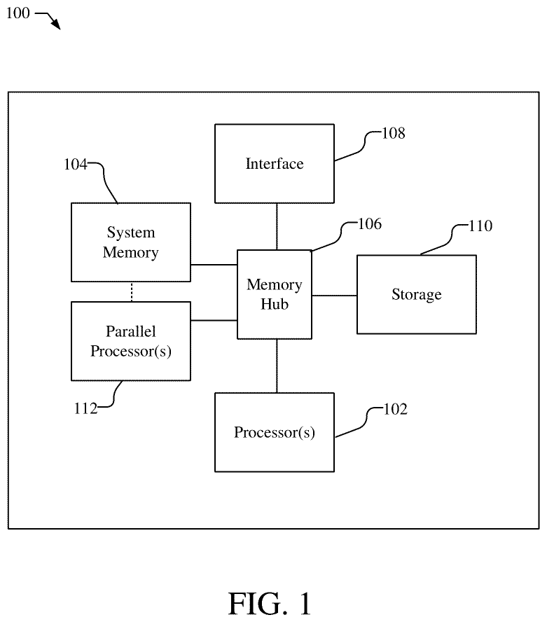

FIG. 1 shows a block diagram of a computing system 100 configured for machine learning acceleration, in accordance with one or more aspects described herein. The computing system 100 includes one or more processors 102 and system memory 104, which may be communicatively coupled via a memory hub 106. The memory hub 106 may be a separate component or may be integrated within the one or more processors 102. The memory hub 106 is further communicatively coupled to an interface 108, data storage 110 and accelerator circuitry in the form of parallel processor(s) 112. The interface 108, for example, may be an interface with an input/output (I/O) sub-system (not shown), which enables the computing system 100 to receive input from one or more input devices and to provide output to one or more display devices or other output devices, including memory.

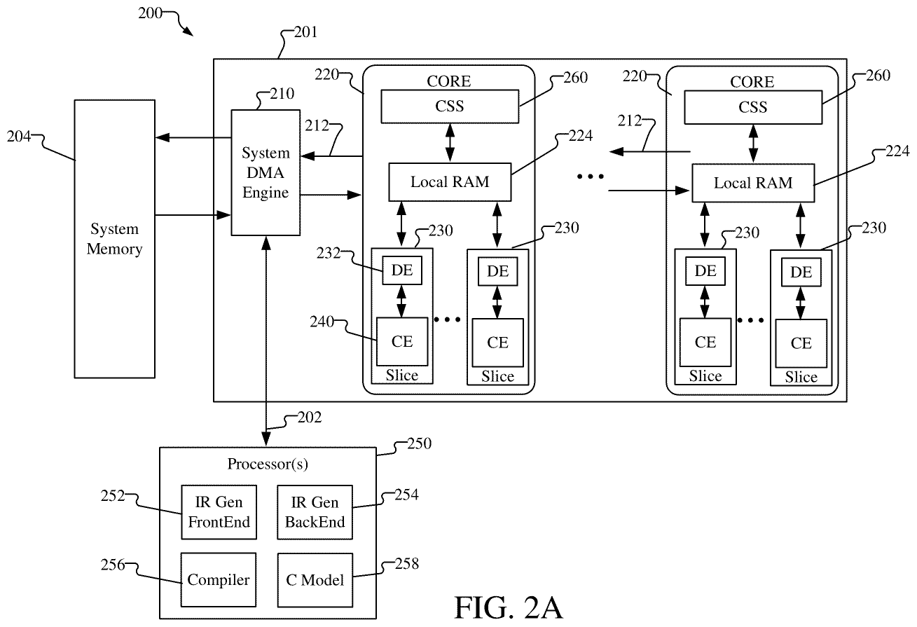

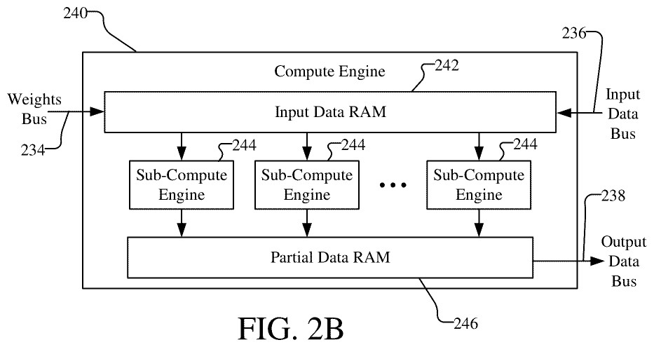

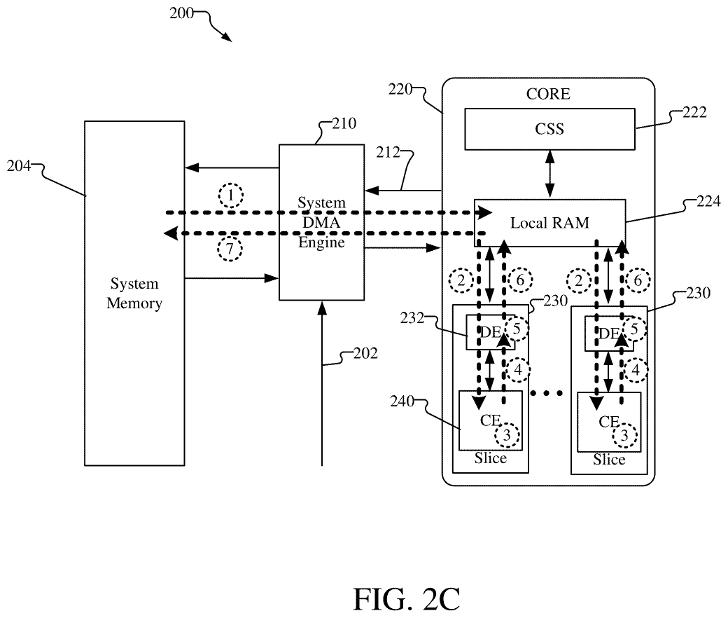

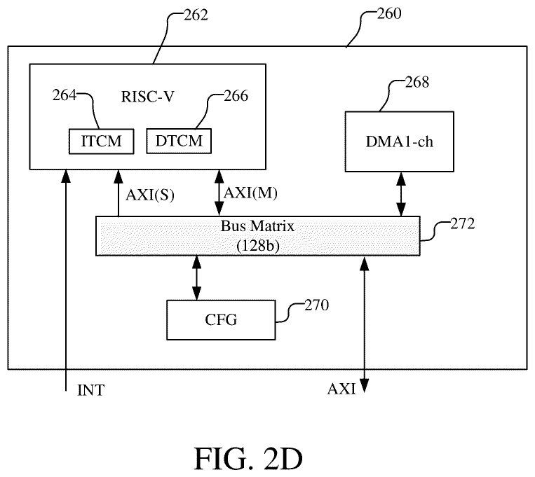

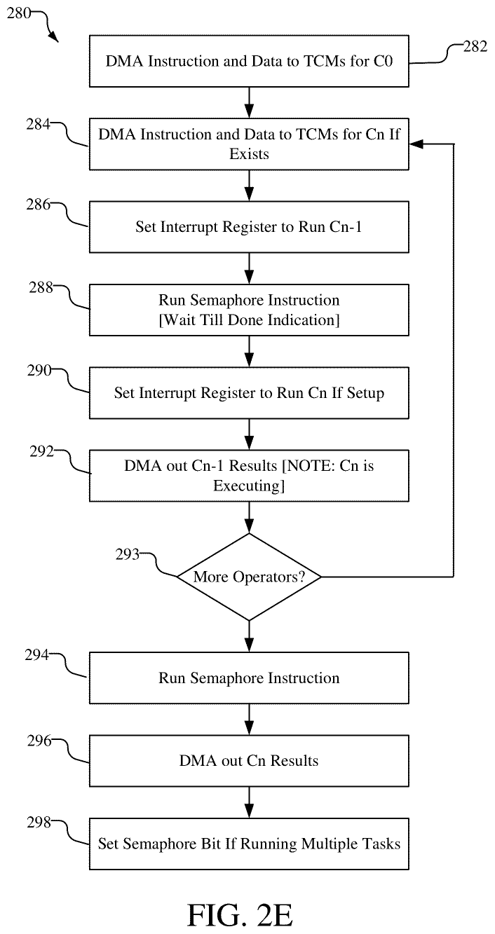

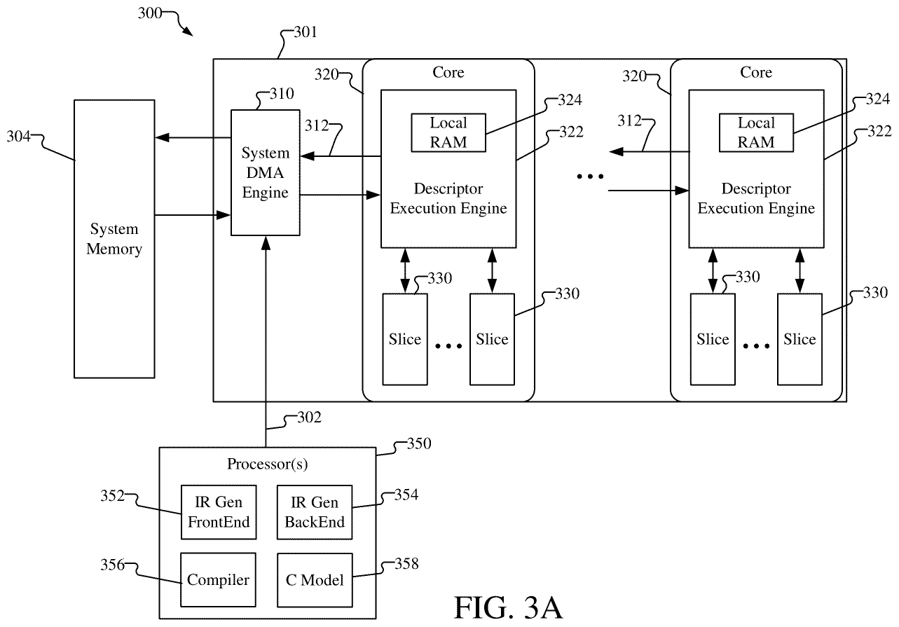

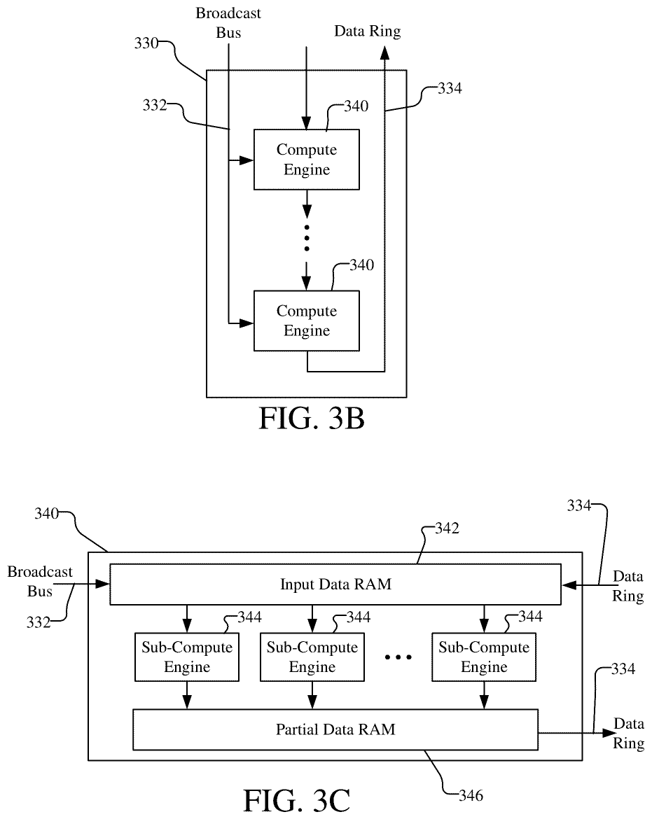

The accelerator circuitry, e.g., parallel processor(s) 112, are communicatively coupled to the system memory 104, e.g., via memory hub 106 or directly, as illustrated with the dotted line. The link between the parallel processor(s) 112 and system memory 104, for example, may be one of any number of standards-based communication link technologies or protocols, such as, but not limited to, PCI Express or the like, or may be a vendor specific communications interface or communications fabric. Similarly, the parallel processor(s) 112 may be communicatively coupled to the one or more processor(s) 102, which may function as a compiler for the parallel processor(s) 112, directly or via memory hub 106. The one or more parallel processor(s) 112 form a parallel processing system and may incorporate circuitry optimized for machine learning algorithms that is scalable and fully programmable, as discussed further, e.g., in FIGS. 2A-2E and FIGS. 3A-3C.

The computing system 100 can include other components not explicitly shown. For example, port connections, optical storage drives, video capture devices, etc. may be communicatively coupled to the computing system 100, e.g., via interface 108. Communication paths interconnecting the various components in FIG. 1 may be implemented using any suitable protocols, such as PCI (Peripheral Component Interconnect) based protocols (e.g., PCI-Express), Advanced extensible Interface (AXI), or any other suitable bus or point-to-point communication interfaces and/or protocol(s), such as the NV-Link high-speed interconnect, or interconnect protocols known in the art.

The components of the computing system 100 may be integrated with one or more other system elements on a single integrated circuit. For example, the one or more parallel processor(s) 112, memory hub 106, processor(s) 102, and interface 108 may be integrated into a system on chip (SoC) integrated circuit. In another example, the components of the computing system 100 may be integrated into a single package to form a system in package (SIP) configuration. In another example, at least a portion of the components of the computing system 100 may be integrated into a multi-chip module (MCM), which can be interconnected with other multi-chip modules into a modular computing system.

The computing system 100 shown herein is illustrative and variations and modifications are possible. The connection topology, including the number and arrangement of bridges, the number of processor(s) 102, and the number of parallel processor(s) 112, may be modified as desired. For instance, in some implementations, system memory 104 may be communicatively coupled to the processor(s) 102 directly rather than through memory hub 106, while other devices communicate with system memory 104 via the memory hub 106 and the processor(s) 102. In some implementations, the parallel processor(s) 112 may be communicatively coupled directly to the interface 108, data storage 110, or one of the one or more processor(s) 102, rather than through the memory hub 106. It should be understood that some of the particular components shown herein, such as data storage 110, are optional and may not be included in all implementations of the computing system 100, or that additional components may be included in the computing system 100. Furthermore, some architectures may use different terminology for components similar to those illustrated in FIG. 1.

FIGS. 2A-2D are block diagrams illustrating the architecture of a machine learning acceleration system 200, according to some implementations. FIG. 2A illustrates the top level of the architecture hardware for the machine learning acceleration system 200. FIG. 2B illustrates the compute engine implemented in the machine learning acceleration system 200. FIG. 2C illustrates a data flow through a portion of the machine learning acceleration system 200. FIG. 2D illustrates the compute sub-system implemented in the machine learning acceleration system 200. The machine learning acceleration system 200, as illustrated in FIG. 2A, for example, includes accelerator circuitry 201, system memory 204, and one or more processor(s) 250, which may respectively serve as parallel processor(s) 112, system memory 104, and processor(s) 102 shown in FIG. 1.

As illustrated in FIG. 2A, the accelerator circuitry 201 is a hierarchical architecture that is a scalable processor, so that it may include different amounts of compute that can be instantiated as desired. The accelerator circuitry 201 includes a system direct memory access (DMA) engine 210 that is communicatively coupled via a host interface 202 to the one or more processors 250 and is communicatively coupled to the system memory 204.

The accelerator circuitry 201 further includes one or more cores 220. A core 220, for example, is a collection of circuits that may be replicated in multiple core instances based on desired compute power and bandwidth. For example, the number of cores 220 that are instantiated may be varied in order to scale the processor and may be selected based on the amount of compute and bandwidth that is desired. By way of example, the accelerator circuitry 201 may include a single core or 32 or 64 or more cores. Any suitable number of cores 220 is possible. As illustrated in FIG. 2A, a core 220 includes a compute sub-system (CSS) 260, local memory (RAM) 224, and multiple slices 230. The core(s) 220 are communicatively coupled to the system DMA engine 210 via an interconnect 212 having any desired topology, such as a star, mesh, bus, tree, or ring. By way of example, for purposes of illustration and not limitation, the interconnect 212 between the system DMA engine 210 and core(s) 220 is illustrated as a data ring, which is sometimes referred to herein as a core ring. Multiple cores 220 may be used to scale the compute beyond slices 230. If multiple cores 220 are present, the cores 220 communicate with each other and the system DMA engine 210 via the interconnect 212, which is sometimes referred to herein as core ring 212 merely an example of an interconnect and not a limitation.

The CSS 260, for example, instantiates the general purpose compute core and associated logic. The CSS 260, for example, may be an RISC-V microprocessor, and may sometimes be referred to as an RCSS, but the CSS 260 is not limited thereto. For example, the CSS 260 may be an ARM M class microprocessor or any other suitable processor or compute core.

The local memory 224, for example, may store data and descriptors. In some implementations, the local memory 224 in a core 220 has a multiplexed direct communicative coupling to the system memory 204 via the system DMA engine 210.

Each core 220 includes one or more slices 230 that may be replicated in multiple instances based on a desired compute power and bandwidth. Each slice 230 includes a descriptor execution engine (DE) 232 and a compute engine (CE) 240. In one implementation, the slices 230 within a core 220 may be independent of each other, i.e., the slices 230 are not directly communicatively coupled to each other.

The descriptor execution engine 232 in each slice 230, for example, executes descriptors to transfer data to and from the compute engine 240 and the local memory 224 in the core 220. The descriptor execution engine 232 may further run activation and scaling functions and operate on shaping the data. The descriptor execution engine 232 may further communicate with the system DMA engine 210 and other cores 220 for synchronization.

The compute engine 240 in each slice 230 is the engine with the multiply-accumulate (MAC) and other logic operations. The compute engine 240, for example, may support multiple compute elements, e.g., up to 256 or more compute elements, although any suitable number of compute elements is possible. Each compute element in the compute engine 240, for example, may have the computation hardware MAC unit. Additionally, the compute engine 240 may include input data memory and partial memory. The input data memory, for example, may hold the input data and weights, while the partial memory may hold the partial data.

FIG. 2B illustrates a more detailed view of a compute engine 240 that may be present in each slice 230 shown in FIG. 2A. Each compute engine 240 includes an input data memory (RAM) 242 that is communicatively coupled to receive data from the local memory 224, e.g., via one or more interconnects illustrated as a weights bus 234 and an input data bus 236. The input data memory 242 in each compute engine 240, for example, may hold the input data and kernels or weights in case of convolution operations. A wide input data memory 242 may be used so that each compute engine 240 may independently hold common data. Each compute engine 240 further includes one or more sub-compute engines 244, each of which is communicatively coupled to the input data memory 242. By way of example, a compute engine 240 may include up to sixteen or more sub-compute engines 244, although any suitable number of sub-compute engines 244 is possible. Each sub-compute engine 244 is configured to perform a desired compute operation, such as, for example, multiply, add, multiply-accumulate (MAC), or multiply-add (MAD) operations. Additionally, each compute engine 240 further includes a partial data memory (RAM) 246, which is communicatively coupled to the output of each of the one or more sub-compute engines 244, and is communicatively coupled to provide output data to the local memory 224 via an interconnect illustrated as the output data bus 238. The partial data memory 246 holds the partial data output produced by the sub-compute engines 244 after processing the input data. When the computation is completed, the compute engine 240 sends the output data back to the descriptor execution engine 232, which applies the activation and scaling functions, and the data is written back to the local memory 224. In some implementations, a compute engine 240 may send an early completion indication to the descriptor execution engine 232. In response, the descriptor execution engine 232 may start sending the next set of input data to the compute engine 240. In some implementations, the data return from the compute engines 240 in each slice 230 in a core 220 is scheduled by the descriptor execution engine 232 in order to keep the data ring busy or otherwise sufficiently loaded and to ensure that the data is returned in optimal order.

The system DMA engine 210, illustrated in FIG. 2A, is configured to receive descriptors from the processor(s) 250 via the host interface 202. The system DMA engine 210 is configured, for example, to execute DMA descriptors received via the host interface 202 and to transfer data from the system memory 204 and core descriptors received via the host interface 202 to the local memory 224 in the cores 220 for operation by the descriptor execution engine 232 in each slice 230. The system DMA engine 210 may be configured to execute additional descriptors received via the host interface 202 as discussed herein. In some implementations, the system DMA engine 210 may be further configured to expand sparse data.

The descriptor execution engine 232 in each slice 230, shown in FIG. 2A, is configured to execute slice descriptors received via the system DMA engine 210, and to send data from the local memory 224 to the compute engine 240 in the slice 230 and to receive data from the compute engines 240 and store the data in the local memory 224. The descriptor execution engine 232 in each slice 230, for example, runs activation and scaling functions and may operate on shaping the data. For example, the descriptor execution engine 232 may include an activation engine for performing activation functions. The descriptor execution engine 232 may further include scaling hardware for performing scaling functions. The descriptor execution engine 232 may be configured to shape the data, e.g., by implementing one or more of add pad functions, transpose the input data array, stride split operations, Parametric Rectified Linear Unit (PreLu) operations, and the like. In some implementations, the descriptor execution engine 232 may be configured for background processing of data, such as stride split operations or the like. The descriptor execution engine 232 may be additionally configured to communicate with the system DMA engine 210 and cores 220 for synchronization, e.g., for providing data to the system DMA engine 210 via the interconnect 212.

As discussed, each compute engine 240, for example, may support a configurable number of sub-compute engines 244, and each sub-compute engine 244 includes the compute hardware to perform a compute operation, such as multiply, add, multiply-accumulate (MAC), or multiply-add (MAD). Thus, each compute engine 240 is configured to perform multiple compute operations. By way of example, a compute engine 240 may be configured to support sixteen or more sub-compute engines 244, although any suitable number of sub-compute engines 244 can be supported. Each sub-compute engine 244 may include hardware for multiple computes. For example, each sub-compute engine 244 may be configured to support one, two, four, or more compute operations. The compute hardware in each sub-compute engine 244 may support 1b (bit), 2b, 4b, 8b, 16b and 32b of data or more. The compute hardware in each sub-compute engine 244 may also support Int8, Int16, BFloat8, BFloat16 and Float32, or other desired formats.

Thus, each compute engine 240 may support any suitable number, e.g., 16 to 64 or more, of MAC or other logic operations. Each core 220 may support any appropriate number, e.g., up to sixteen or more, slices 230. In an implementation, each core 220 may support, for example, 8 TOPS (trillions of operations per second) at 1 GHz. Accordingly, for purposes of illustration and not limitation, with eight cores 220, the machine learning acceleration system 200 may support 64 TOPS. Other numbers of operations at different frequencies are possible.

The distribution of data to the one or more cores 220, to the slices 230 in each core, and to the compute engine 240 in each slice 230, is controlled by the processor(s) 250. For example, if a large amount of input data is present, the processor(s) 250 may cause the system DMA engine 210 to divide and to distribute the data to different cores 220 via the interconnect 212. The communication between the cores 220 via the interconnect 212 may be minimized, e.g., with only top and bottom portions of data such as pad information being transferred, to increase efficiency of the cores 220. As another example, if the amount of input data is small, but a large number of channels is desired, the processor(s) 250 may cause the system DMA engine 210 to distribute the data to all the cores 220 and each core 220 may generate a different channel.

As illustrated, the processor(s) 250 are communicatively coupled to the system DMA engine 210 via the host interface 202. The processor(s) 250 are configured to implement various modules or components as discussed herein. The modules or components may be implemented in hardware, software, firmware, or any combination thereof, unless specifically described as being implemented in a specific manner. Moreover, any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials. In the figure, a single block may be described as performing a function or functions; however, in actual practice, the function or functions performed by that block may be performed in a single component or across multiple components, and/or may be performed using hardware, using software, using firmware, or using any combination thereof.

As illustrated, the processor(s) 250 may be configured to implement an Intermediate Representation Generate FrontEnd (IR Gen FrontEnd) module 252, which accepts a neural network model and generates an intermediate representation (IR) to the backend. The IR Gen FrontEnd module 252 may be configured to implement an architecture agnostic model of the machine learning acceleration system 200 but implements only the functions that are available in the hardware. The IR Gen FrontEnd module 252 may generate intermediate data for all the layers of the neural network that is being executed. The intermediate data, for example, may include all the input data, expected output data, and the data before activation and scaling in the descriptor execution engine 232 in each slice 230.

The processor(s) 250 may be further configured to implement an Intermediate Representation Generate BackEnd (IR Gen BackEnd) module 254, which may accept the IR from the IR Gen FrontEnd module 252 and generate IR to a compiler 256. The IR Gen BackEnd module 254, for example, may be responsible for managing the memory in the machine learning acceleration system 200. The IR Gen BackEnd module 254 may also implement tiling functions if used in the neural network.

The processor(s) 250 may be further configured to implement the compiler 256, sometimes simply referred to as compiler 256, which may accept the IR from the IR Gen BackEnd module 254 and generate a compiled output to run on a C model 258, which may be a register-transfer level (RTL), field programmable gate array (FPGA), application specific integrated circuit (ASIC), or the like. The compiler 256 may further provide the compiled output to the system DMA engine 210 via the host interface 202. In some implementations, the compiler 256 may be configured for support for function calls with arguments.

The processor(s) 250 may be further configured to implement the C model 258, which is functionally accurate as the RTL design of the hardware implemented in the accelerator circuitry 201. The implementation of the C model 258 mimics the hardware in the machine learning acceleration system 200. Thus, the implementation of the C model 258 is exposed to the input data and output data of the compute engines 240, the data in the input data memory 242, the data in the partial data memory 246, etc., in each slice 230 of each core 220. The C model 258 further implements a concept of clock, which may be used for debugging and to measure performance. In some implementations, the C model 258 performance may be, e.g., 95% or more close to the hardware in the accelerator circuitry 201.

As discussed above, the machine learning acceleration system 200 may include hardware for multiple compute operations for each sub-compute engine 244, e.g., each sub-compute engine 244 may be configured to support one, two, four, or more computation operations, and support 1b (bit), 2b, 4b, 8b, 16b and 32b of data, and Int8, Int16, BFloat8, BFloat16 and Float32 formats.

Additionally, multiple modes of data operation may be implemented in order to maintain a high efficiency. The various modes of data operation, for example, may be controlled by the compiler 256. The architecture supports parallel calculation, e.g., on 256 input data using 256 compute elements, although more or less input data and compute elements are possible. Merely for purposes of illustration and not limitation, the 256 compute elements may consume 64 input data, broadcast it to four sets of compute elements and generate four output channels, which may be referred to as 64×4 mode. The architecture may support 32×8 and 16×16 modes, as well, e.g., where it generates eight output channels and sixteen output channels, respectively, although other modes are possible. When the input data frame size is small, the compiler 256 may send input data via the weights bus 234 to the compute engine 240, which is sometimes referred to as dense mode. By way of example, full connected layer and matrix multiplication may utilize dense mode to achieve high efficiency.

In some implementations, the system DMA engine 210 may include prefetch buffers, which, for example, may be implemented in response to instructions from the compiler 256. The system DMA engine 210, for example, may include a prefetch buffer for each data structure. During operation, the compiler 256 may provide instructions to the system DMA engine 210 with what will be executed next, e.g., the data structure and address that will be executed next. The system DMA engine 210 accordingly prefetches the appropriate data and stores the data in the prefetch buffers while current execution is being performed.

In some implementations, the machine learning acceleration system 200 may further implement a SoftMax unit or the like.

Thus, the machine learning acceleration system 200 is scalable and fully programable to be used with any desired artificial intelligence (AI) applications. By way of example, various hardware parameters may be selected based on the desired application. For example, the local memory 224 may be instantiated with a desired number of banks. Additional parameters that may be selected based on the desired application, including the number of compute operations per sub-compute engine 244, the number of sub-compute engines 244 per compute engine 240, the number of slices 230 per core 220, and the number of cores 220. Additional parameters of the sub-compute engine 244 that may be configured may include the number of bits supported, e.g., 1b, 2b, 4b, 8b, 16b and 32b of data, and the compute data type that is supported, e.g., Int8, Int16, BFloat8, BFloat16 and Float32 formats. An additional parameter that may be selected is the precision of the multi-precision deflate support of the compute engine 240. The prefetch buffer size of the system DMA engine 210 may be selected. Further, the data width of the buses, e.g., AXI or the like, are parameters that may be selected. Additionally, the depth of the input data memory 242 and the depth of the partial data memory 246 in each compute engine 240 are parameters that may be selected.

Efficient data transfer within the accelerator circuitry 201 is desirable for high utilization of the hardware. The data transfer, for example, is between system memory 204, which can be external to the accelerator circuitry 201, and the local memory (local memory 224) in each core 220, between the local memory (local memory 224) and the compute engines 240 within each core 220, and between cores 220.

FIG. 2C, by way of example, illustrates a high-level data flow through a portion of the machine learning acceleration system 200, according to some implementations. The machine learning acceleration system 200 illustrated in FIG. 2C illustrates the system memory 204, system DMA engine 210, and a single core 220 including CSS 260, local memory 224, and two slices 230 each with a descriptor execution engine 232 and compute engine 240.

As illustrated, in a first (1) operation, data is fetched from the system memory 204 and stored in the local memory 224 of the core 220. In a second (2) operation, the data is sent from the local memory 224 to the compute engine 240 in each slice 230. The compute engine 240 performs the desired computation with the data in a third (3) operation, and, in a fourth (4) operation, sends the computed data back to the descriptor execution engine 232. In a fifth (5) operation, the descriptor execution engine 232 may perform activation and/or scaling, if desired. The descriptor execution engine 232 writes the data back to the local memory 224 in a sixth (6) operation. In a seventh (7) operation, the data is sent from the local memory 224 to the system memory 204.

All of the above operations may be run in parallel to achieve high efficiency and utilization. The compiler 256, shown in FIG. 2A, for example, may generate descriptors for each of the above operations. Each of the above operations are controlled via independent descriptors running for each operation. The compiler 256 may “trigger” each of these descriptors so that they are working in parallel.

The model, descriptors and activation data may be stored in the system memory 204. Descriptors, model, and activation data are read from the system memory 204 and stored in the local memory 224 as needed. The amount of data to retrieve and the location of the data in the local memory 224 is controlled by the compiler 256.

There are multiple descriptors to send data from or to the local memory 224 and to or from the lowest compute component in the compute engine 240. Descriptors, for example, may be linked via linked lists. Linked descriptors execute as specified in the link list, e.g., one after the other.

Each slice 230 in a core 220 operates independently, i.e., there is no hardware required dependency between slices 230 on when to start a computation and when to end. Additionally, the hardware in each slice 230 supports a semaphore descriptor. Accordingly, when the slices 230 need to operate on related data, the compiler 256 may start each slice operation independently and then join the resulting data via a semaphore.

To improve utilization, each slice 230 and general purpose compute in the CSS 260 can be operated independently running on separate “tasks.” In such cases, the host software, e.g., run by host processor 250, such as the compiler 256, can co-ordinate the operation and synchronization of various tasks.

Additionally, to improve utilization and memory latency, the compiler 256 may operate the data transfer from the system memory 204 to local memory 224 in a ping-pong fashion. That is, the compiler 256 may organize the local memory 224 into two sections, e.g., section A and section B. Initially data, model and descriptors are brought into section A and slices 230 start operations from section A. As section A operations begin, the next set of data is brought into section B in parallel. Thus, the computation time for section A overlaps with the data fetch for section B. Similarly, while the slices 230 operate on section B, new data may be brought into section A. The compiler 256 should ensure that the compute in section A is large enough to cover the memory latency to fetch for section B. The output from the local memory 224 to the system memory 204 may be the final compute result, but in some instances, may be a partial result that is read back later to complete the computations.

As illustrated in FIG. 2A, each core 220 instantiates a CSS 260 to support operations that are not run in the slices 230 and supports multi-tasking. The CSS 260, by way of example, may instantiate a RISC-V core or an ARM M class microprocessor or the like. The CSS 260 operates in parallel with the slices 230. The CSS 260, for example, may receive input data and compiled instructions from the local memory 224. The CSS 260 may be used to run subroutines only. For example, the CSS 260 may be used to run parts of the network that cannot be accelerated on the hardware of the machine learning acceleration system 200.

FIG. 2D, by way of example, illustrates the CSS 260 instantiated with a RISC-V core 262, which instantiates an instruction tightly coupled memory (ITCM) 264 and data tightly coupled memory (DTCM) 266 (collectively referred to as the TCMs 264 and 266). The ITCM 264, for example, may include 8 KB of instruction TCM, and the DTCM 266 may include 32 KB of instruction TCM, although other suitable amounts of instruction TCM are possible. The RISC-V core 262 may serve as a “slave” to the remainder of the machine learning acceleration system 200 system, i.e., the remainder of the machine learning acceleration system 200 can be responsible for managing the TCMs 264 and 266 and sending an interrupt to the RISC-V core 262 to start the computation. The RISC-V core 262 performs a write over Advanced extensible Interface (AXI) (or other suitable interface) to the core system register to indicate completion of computation.

The CSS 260 may further include direct memory access (DMA) 268, which may include, for example, one channel and is used to transfer data between the local memory 224 and the ITCM 264 and DTCM 266. Additionally, the CSS 260 may include a Configuration Register Space (CFG) 270, and a bus matrix 272 that communicatively couples the CFG 270, DMA 268, RISC-V core 262, and the local memory 224 via an AXI interface. The bus matrix 272, for example, may be an interconnect with 128b bandwidth. Additionally, the RISC-V core 262 may be communicatively coupled to the local memory 224 directly via an interrupt (INT) interface or the like.

For purposes of illustration and not limitation, the following are components to run operators or compute on the RISC-V core 262. As sometimes used herein, RCSS may refer to the RISC-V compute sub-system, while NCSS may refer to the numerical processor unit (NPU) compute sub-system, which is the machine learning acceleration system 200 without the RCSS. The RCSS may include an interrupt register, where setting a bit in this register via software write causes an interrupt to the RISC-V core 262. The RCSS may further include a RISC-V Done register where the RISC-V sets this bit when a computation is completed. This register may be polled by a semaphore instruction. The ITCM 264 and DTCM 266 are tightly coupled memory instantiated in the RISC-V core 262. Any section of TCMs 264 and 266 may be written to by the DMA 268 via AXI interface. The TCMs 264 and 266 may be read or written to while the RISC-V operation is in progress. Semaphore instruction is the barrier instruction. The DMA 268 executes a list of linked descriptors. The DMA 268 may read data from the local memory 224 and send data to registers in the RCSS or to the TCMs 264 or 266 in the RISC-V core 262 or read from the TCMs 264 or 266 and write to the local memory 224. A semaphore instruction stops the descriptor execution in the link list till the semaphore bit is set. Semaphore can be run in areas of the machine learning acceleration system 200 other than the RCSS as well.

FIG. 2E shows a flow chart 280 illustrating the operators running on the RCSS, e.g., the RISC-V CSS 260 illustrated in FIG. 2D, in double buffer mode. Double buffer may be a software mechanism. In double buffer mode, the TCMs 264 or 266 are read/written while the previous compute is in progress in the CSS 260. The Interrupt Service Routine (ISR) running on the RISC-V core 262 has a location that indicates the location in the ITCM 264 to execute in response to an interrupt. For double buffer mechanisms, the ISR checks two locations in ping-pong fashion in the memory to determine which sub routine to run on interrupt. There may be multiple link list of descriptors in the NCSS. Each of the link lists may be running in parallel on multiple computes, e.g., in multiple slices 230 and in the CSS 260 (e.g., RCSS), representing multiple parallel tasks. Each of these lists may be synchronized via semaphore instruction. Multiple semaphore instructions back-to-back, one for each link list would act as “join” for the multiple threads.

Each of the tasks may be “started” by the runtime software running on the processor 250, possibly multiple times within a single network run. The runtime software plays a key role in ensuring full parallelism is achieved via multiple tasks on the hardware. In “typical” single task systems, the runtime software kicks off the single task and waits for single done indication. The hardware in the machine learning acceleration system 200 support this option for a single done bit for all compute operations.

The flow chart 280 illustrates descriptors setup for running operators running on the RCSS back-to-back, as a representation of a double buffered setup. This can be set up as part of a single large link list running operations on NCSS or separate tasks as mentioned above. In flow chart 280, if the compute running on NCSS has dependence on RCSS output and runtime code does not need to be involved, the compiler 256 would insert the NCSS descriptors after the DMA 268 transfer completion indication (another semaphore instruction).

As illustrated, at block 282, the DMA 268 sends instruction and data to the TCMs 264 and 266 for Co. At block 284, the DMA 268 additionally sends instruction and data to the TCMs 264 and 266 for Cn, if it exists, where Cn indicates a separate compute operation. At block 286, the interrupt register is set to run Cn−1, and at block 288, a semaphore instruction is run and will wait until there is a done indication. At block 290, the interrupt register is set to run Cn, if it is set up, e.g., at block 284. At block 292, the DMA 268 outputs the results from Cn−1, while Cn is executing. At block 293, if there are more operators, the flow returns to block 284. At block 294, a semaphore instruction is run, and at block 296, the DMA 268 outputs the Cn results. At block 298, a semaphore bit is set if running multiple tasks.

The machine learning acceleration system 200 implements several useful features that are not found in conventional systems. For example, a useful feature that may be implemented by the machine learning acceleration system 200 is the concept of tasks. As AI models get bigger and more complex, running these models on an accelerator as a single network becomes more complicated and leads to reduced performance. With the machine learning acceleration system 200, each of the sub-computes, e.g., slices 230, CSS 260, cores 220, etc., run independently. The compiler 256, accordingly, may split the large model into multiple sub-models and each sub-model may run independently on the multiple sub-computes. This feature enables transformer models to be run separately from complex vision models efficiently.

Additionally, the machine learning acceleration system 200 enables memory bandwidth reduction and latency absorption. Memory bandwidth is a critical resource that is often limited when running models. The local memory 224 in each core 220 may act as the software-controlled cache or buffer to reduce memory bandwidth and absorb large latencies. The local memory 224 allows the compiler 256 to implement tiling optimizations to reduce or eliminate writing of activation data to the system memory 204 thereby reducing memory bandwidth. Absorption of large latencies is important so that the system cache is not “polluted” with read once data. The use of the software controlled cache or buffer allows the compiler 256 to fetch data in parallel with the computations so that large memory latencies are not a bottleneck.

Additionally, the machine learning acceleration system 200 implements various techniques, such as channel grouping and data transpose, to achieve high utilization for all data sizes. Conventional systems run layers with typically large data sizes efficiently but fall short on layers with smaller data sizes. Channel grouping and data transpose techniques allow the machine learning acceleration system 200 to run layers of all data sizes efficiently.

Further, the machine learning acceleration system 200 enables optimization for depthwise, dense, and matrix multiplication operations. Depthwise, dense, and matrix multiplication operations typically lead to reduced utilization in conventional architectures. The machine learning acceleration system 200 efficiently implements buses and transformations that allow these operations to run at substantially better, e.g., 5×-10×, utilizations than conventional systems.

The machine learning acceleration system 200 further provides native support for Int16 and BFloat16 formats. Int16 is required to support, for example, audio networks. With the transformer models, quantization techniques may be introduced to reduce the model size without compromising accuracy. Consequently, the models might not run at Int8 resolution. The machine learning acceleration system 200 natively supports running BFloat16 data format along with the required quantization techniques, which aids with the memory bandwidth. Additionally, the model fetched from memory may be small in size and expanded to float format within the machine learning acceleration system 200.

The machine learning acceleration system 200 additionally support tables and gather operators. Table operator and gather operator along with the BFloat16, for example, allows for any single input floating point or integer operation to be completed in few cycles, which is useful to achieve high performance for any operator apart from supporting “all” operators.

The machine learning acceleration system 200 enables an embedded general-purpose compute, which may be tightly coupled with the table/gather operations to reduce the need for running any part of the model on the host. Running any part of the model on the host drastically reduces performance. With the machine learning acceleration system 200, there is no need to run any component on the host. The host may only be used to schedule running of models or sub-models on the machine learning acceleration system 200 compute.

Additionally, the machine learning acceleration system 200 may reduce the required size on silicon. The machine learning acceleration system 200, for example, is a software-controlled architecture. Thus, the hardware does not implement any hard functions. Apart from being highly flexible, this leads to an efficient hardware implementation from an area perspective.

FIGS. 3A-3C are block diagrams illustrating another architecture of a machine learning acceleration system 300, according to some implementations. The machine learning acceleration system 300 may be similar to the machine learning acceleration system 200. The machine learning acceleration system 300 shown in FIG. 3A, for example, includes accelerator circuitry 301, system memory 304, and one or more processor(s) 350, which may respectively serve as parallel processor(s) 112, system memory 104, and processor(s) 102 shown in FIG. 1.

As illustrated in FIG. 3A, the accelerator circuitry 301 is a hierarchical architecture that is a scalable processor, so that it may include different amounts of compute that can be instantiated as desired. The accelerator circuitry 301 includes a system direct memory access (DMA) engine 310 that is communicatively coupled via a host interface 302 to the one or more processors 350 and is communicatively coupled to the system memory 304.

The accelerator circuitry 301 further includes one or more cores 320. A core 320, for example, is a collection of circuits that may be replicated in multiple core instances based on desired compute power and bandwidth. For example, the number of cores 320 that are instantiated may be varied in order to scale the processor and may be selected based on the amount of compute and bandwidth that is desired. By way of example, the accelerator circuitry 301 may include a single core or 32 or 64 or more cores, although any suitable number of cores 320 is possible. As illustrated in FIG. 3A, a core 320 may include a descriptor execution engine 322, which is communicatively coupled to the system DMA engine 310 via an interconnect 312 having any desired topology, such as a star, mesh, bus, tree, or ring. By way of example, for purposes of illustration and not limitation, in FIG. 3A the interconnect 312 between the system DMA engine 310 and descriptor execution engine 322 is illustrated as a data ring, which is sometimes referred to herein as a core ring. If multiple cores 320 are present, the cores 320 communicate with each other and the system DMA engine 310 via the interconnect 312, which is sometimes referred to herein as core ring 312 merely as an example and not a limitation. The descriptor execution engine 322 includes local memory (RAM) 324 that stores data and descriptors. In some implementations, the local memory 324 in a core 320 has a multiplexed direct communicative coupling to the system memory 304 via the system DMA engine 310. Each core 320 further includes a one or more slices 330, e.g., a sub-collection of circuits that may be replicated in multiple instances in each slice 330 based on a desired compute power and bandwidth. Each slice 330 is communicatively coupled to the descriptor execution engine 322. In one implementation, the slices 330 within a core 320 may be independent of each other, i.e., the slices 330 are not directly communicatively coupled to each other.

FIG. 3B illustrates a more detailed view of a single slice 330 that may be present in a core 320 shown in FIG. 3A. As illustrated, the slice 330 includes one or more compute engines 340, e.g., up to four or more. In some implementations, each separate slice 330 in a core 320 may include the same number of compute engines. All of the compute engines 340 within the slice 330 are jointly communicatively coupled to the local memory 324 in the core 320 via one or more interconnects illustrated as a broadcast bus 332 and a data ring 334. Each separate slice 330 in a core 320 is independent of each other but are similarly communicatively coupled to the local memory 324 in the core 320 via broadcast buses and data rings.

FIG. 3C illustrates a more detailed view of a compute engine 340 that may be present in slice 330 shown in FIG. 3B. Each compute engine 340 includes an input data memory (RAM) 342 that is communicatively coupled to receive data from the local memory 324 via one or more interconnects illustrated as the broadcast bus 332 and the data ring 334. The input data memory 342 in each compute engine 340, for example, may hold the input data and kernels or weights in case of convolution operations. A wide input data memory 342 may be used so that each compute engine 340 may independently hold common data and the compute engines 340 can be independent of each other. Each compute engine 340 further includes one or more sub-compute engines 344, each of which is communicatively coupled to the input data memory 342. By way of example, a compute engine 340 may include up to sixteen or more sub-compute engines 344, although any suitable number of sub-compute engines 344 is possible. Each sub-compute engine 344 is configured to perform a desired compute operation, such as multiply, add, multiply-accumulate (MAC), or multiply-add (MAD) operations. Additionally, each compute engine 340 further includes a partial data memory (RAM) 346, which is communicatively coupled to the output of each of one or more sub-compute engines 344, and is communicatively coupled to provide output data to the local memory 324 via the data ring 334. The partial data memory 346 holds the partial data output produced by the sub-compute engines 344 after processing the input data. When the computation is completed, the compute engine 340 sends the output data back to the descriptor execution engine 322, which applies the activation and scaling functions, and the data is written back to the local memory 324. In some implementations, a compute engine 340 may send an early completion indication to the descriptor execution engine 322. In response, the descriptor execution engine 322 may start sending the next set of input data to the compute engine 340. In some implementations, the data return from the compute engines 340 in each slice 330 in a core 320 is scheduled by the descriptor execution engine 322 in order to keep the data ring busy or otherwise sufficiently loaded and to ensure that the data is returned in optimal order.

The system DMA engine 310, illustrated in FIG. 3A, is configured to receive descriptors from the processor(s) 350 via the host interface 302. The system DMA engine 310 is configured, for example, to execute DMA descriptors received via the host interface 302 and to transfer data from the system memory 304 and core descriptors received via the host interface 302 to the local memory 324 in the cores 320 for operation by the descriptor execution engine 322. The system DMA engine 310 may be configured to execute additional descriptors received via the host interface 302 as discussed herein. In some implementations, the system DMA engine 310 may be further configured to expand sparse data.

The descriptor execution engine 322 in each core 320, shown in FIG. 3A, is configured to execute core descriptors received via the system DMA engine 310, and to send data from the local memory 324 to the compute engines 340 in the slices 330 and to receive data from the compute engines 340 and store the data in the local memory 324. The descriptor execution engine 322 in each core, for example, runs activation and scaling functions and may operate on shaping the data. For example, the descriptor execution engine 322 may include an activation engine for performing activation functions. The descriptor execution engine 322 may further include scaling hardware for performing scaling functions. The descriptor execution engine 322 may be configured to shape the data, e.g., by implementing one or more of add pad functions, transpose the input data array, stride split operations, Parametric Rectified Linear Unit (PreLu) operations, and the like. In some implementations, the descriptor execution engine 322 may be configured for background processing of data, such as stride split operations or the like. The descriptor execution engine 322 may be additionally configured to communicate with the system DMA engine 310 and cores 320 for synchronization, e.g., for providing data to the system DMA engine 310 via the interconnect 312.

As discussed, each compute engine 340, for example, may support a configurable number of sub-compute engines 344, and each sub-compute engine 344 includes the compute hardware to perform a compute operation, such as, for example, multiply, add, multiply-accumulate (MAC), or multiply-add (MAD). Thus, each compute engine 340 is configured to perform multiple compute operations. By way of example, a compute engine 340 may be configured to support sixteen or more sub-compute engines 344, although any suitable number of sub-compute engines 344 is possible. Each sub-compute engine 344 may include hardware for multiple computes. For example, each sub-compute engine 344 may be configured to support one, three, four, or more compute operations. The compute hardware in each sub-compute engine 344 may support 1b (bit), 3b, 4b, 8b, 16b and 32b of data or more. The compute hardware in each sub-compute engine 344 may also support Int8, Int16, BFloat8, BFloat16 and Float32, or other desired formats.

Thus, each compute engine 340 in a slice 330 may support any suitable number, e.g., 16 to 64 or more, of MAC or other logic operations. Each slice 330 may support any suitable number, e.g., up to four or more, compute engines 340. Moreover, each core 320 may support a number, e.g., up to sixteen or more, slices 330. In an implementation, each core 320 may support, for example, 8 TOPS (trillions of operations per second) at 1 GHz, although other appropriate numbers of operations at different frequencies are possible. Accordingly, for purposes of illustration and not limitation, with four cores 320, the machine learning acceleration system 300 may support 32 TOPS.

The distribution of data to the one or more cores 320, to the slices 330 in each core 320, and to the compute engine 340 in each slice 330, is controlled by the processor(s) 350. For example, if a large amount of input data is present, the processor(s) 350 may cause the system DMA engine 310 to divide and to distribute the data to different cores 320 via the interconnect 312. The communication between the cores 320 via the interconnect 312 may be minimized, e.g., with only top and bottom portions of data such as pad information being transferred, to increase efficiency of the cores 320. As another example, if the amount of input data is small, but a large number of channels is desired, the processor(s) 350 may cause the system DMA engine 310 to distribute the data to all the cores 320 and each core 320 may generate a different channel.

As illustrated, the processor(s) 350 are communicatively coupled to the system DMA engine 310 via the host interface 302. The processor(s) 350 are configured to implement various modules or components as discussed herein. The modules or components may be implemented in hardware, software, firmware, or any combination thereof, unless specifically described as being implemented in a specific manner. Moreover, any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials. In the figure, a single block may be described as performing a function or functions; however, in actual practice, the function or functions performed by that block may be performed in a single component or across multiple components, and/or may be performed using hardware, using software, using firmware, or using any combination thereof.

As illustrated, the processor(s) 350 may be configured to implement an Intermediate Representation Generate FrontEnd (IR Gen FrontEnd) module 352, which accepts a neural network model and generates an intermediate representation (IR) to the backend. The IR Gen FrontEnd module 352 may be configured to implement an architecture agnostic model of the machine learning acceleration system 300 but implements only the functions that are available in the hardware. The IR Gen FrontEnd module 352 may generate intermediate data for all the layers of the neural network that is being executed. The intermediate data, for example, may include all the input data, expected output data, and the data before activation and scaling in the descriptor execution engine 322.

The processor(s) 350 may be further configured to implement an Intermediate Representation Generate BackEnd (IR Gen BackEnd) module 354, which may accept the IR from the IR Gen FrontEnd module 352 and generate IR to a compiler 356. The IR Gen BackEnd module 354, for example, may be responsible for managing the memory in the machine learning acceleration system 300. The IR Gen BackEnd module 354 may also implement tiling functions if used in the neural network.

The processor(s) 350 may be further configured to implement the compiler 356, which may accept the IR from the IR Gen BackEnd module 354 and generate a compiled output to run on a C model 358, which may be a register-transfer level (RTL), field programmable gate array (FPGA), application specific integrated circuit (ASIC), or the like. The compiler 356 may further provide the compiled output to the system DMA engine 310 via the host interface 302. In some implementations, the compiler 356 may be configured for support for function calls with arguments.

The processor(s) 350 may be further configured to implement the C model 358, which is functionally accurate as the RTL design of the hardware implemented in the accelerator circuitry 301. The implementation of the C model 358 mimics the hardware in the machine learning acceleration system 300. Thus, the implementation of the C model 358 is exposed to the input data and output data of the compute engines 340, the data in the input data memory 342, the data in the partial data memory 346, etc., in each slice 330 of each core 320. The C model 358 further implements a concept of clock, which may be used for debugging and to measure performance. In some implementations, the C model 358 performance may be, e.g., 95% or more close to the hardware in the accelerator circuitry 301.

As discussed above, the machine learning acceleration system 300 may include hardware for multiple compute operations for each sub-compute engine 344, e.g., each sub-compute engine 344 may be configured to support one, three, four, or more computation operations, and support 1b (bit), 3b, 4b, 8b, 16b and 32b of data, and Int8, Int16, BFloat8, BFloat16 and Float32 formats.

Additionally, multiple modes of data operation may be implemented in order to maintain a high efficiency. The various modes of data operation, for example, may be controlled by the compiler 356. As an example, in one mode of data operation, referred to herein as Mode 0, the input data may be provided to each compute engine 340 via the data ring 334 and the kernels or weights for the convolution operation are sent to each compute engine 340 via the broadcast bus 332. In another mode of data operation, referred to herein as Mode 1, the input data may be provided to each compute engine 340 via the broadcast bus 332 and the kernels or weights for the convolution operation are sent to each compute engine 340 via the data ring 334, for example, if the size of the kernels for the convolution operation are much larger than the input data. By way of example, full connected layer matrix multiplication may utilize Mode 1 to achieve high efficiency. In another mode of data operation, referred to herein as Mode 3, each compute engine 340 may operate on a different set of output channels. For example, if each compute engine 340 receives the same input data via broadcast bus 332, but different kernels via the data ring 334, the compute engines 340 will generate different outputs, which are provided on a different set of output channels. In another mode of data operation, referred to herein as Mode 4, each compute engine 340 works on a different set of output channels, similar to Mode 3, except that it is applicable to depth-wise operations. In some implementations, the machine learning acceleration system 200, discussed in FIGS. 2A-2E, may implement one or more of the above described modes. Moreover, in some implementations, the machine learning acceleration system 300 may further implement one or more of the modes and operations, discussed above in reference to machine learning acceleration system 200.

In some implementations, the system DMA engine 310 may include prefetch buffers, which, for example, may be implemented in response to instructions from the compiler 356. The system DMA engine 310, for example, may include a prefetch buffer for each data structure. During operation, the compiler 356 may provide instructions to the system DMA engine 310 with what will be executed next, e.g., the data structure and address that will be executed next. The system DMA engine 310 accordingly prefetches the appropriate data and stores the data in the prefetch buffers while current execution is being performed.

In some implementations, the machine learning acceleration system 300 may further implement a SoftMax unit or the like.

The machine learning acceleration system 300, thus, is scalable and fully programable to be used with any desired artificial intelligence (AI) applications. By way of example, various hardware parameters may be selected based on the desired application. For example, the local memory 324 may be instantiated with a desired number of banks. Additional parameters that may be selected based on the desired application include the number of compute operations per sub-compute engine 344, the number of sub-compute engines 344 per compute engine 340, the number of compute engines 340 per slice 330, the number of slices 330 per core 320, and the number of cores 320. Additional parameters of the sub-compute engine 344 that may be configured may include the number of bits supported, e.g., 1b, 3b, 4b, 8b, 16b and 32b of data, and the compute data type that is supported, e.g., Int8, Int16, BFloat8, BFloat16 and Float32 formats. An additional parameter that may be selected is the precision of the multi-precision deflate support of the compute engine 340. The prefetch buffer size of the system DMA engine 310 may be selected. Further, the data width of the buses, e.g., AXI or the like, are parameters that may be selected. Additionally, the depth of the input data memory 342 and the depth of the partial data memory 346 in each compute engine 340 are parameters that may be selected.

Efficient data transfer within the accelerator circuitry 301 is desirable for high utilization of the hardware. The data transfer, for example, is between system memory 304, which can be external to the accelerator circuitry 301, and the local memory (local memory 324) in each core 320, between the local memory (local memory 324) and the compute engines 340 within each core 320, and between cores 320.

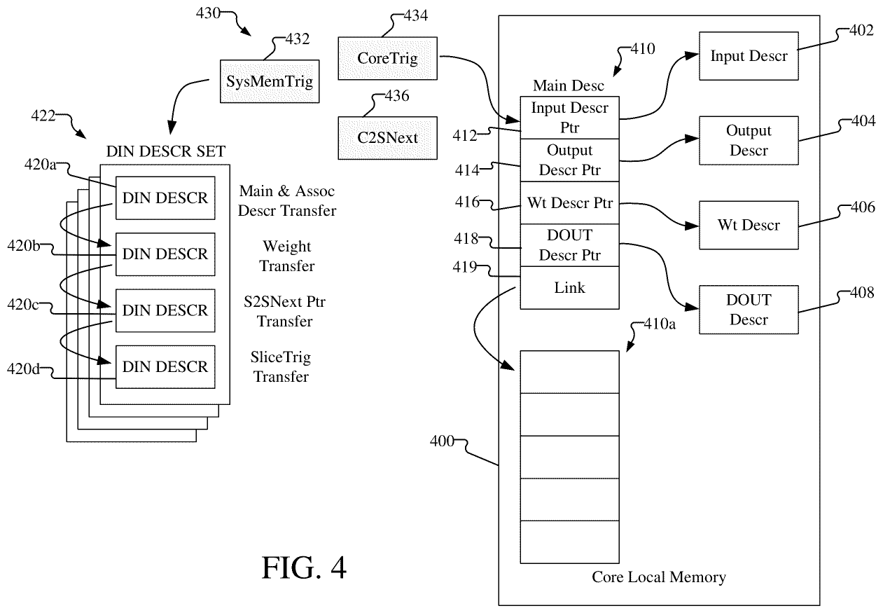

FIG. 4 schematically illustrates an organization of registers and descriptors used in a machine learning acceleration system, such as machine learning acceleration system 200, for basic data transfer functionality between the system memory, which can be external to the accelerator circuitry, and the core local memory. While FIG. 4 is described in reference to machine learning acceleration system 200 illustrated in FIGS. 2A-2E, it should be understood that FIG. 4 may be applied to other machine learning acceleration systems, such as the machine learning acceleration system 300 shown in FIGS. 3A-3B. FIG. 4, for example, illustrates a core local memory 400, which may be local memory 224 shown in FIG. 2A, and the organization of various descriptors, as well as a plurality of registers 430 that enable basic data transfer functionality. Moreover, it should be understood that the organization and description of registers and descriptors provided in FIG. 4 is merely an example and not a limitation, and other registers, descriptors, and organizations thereof may be used if desired.

The machine learning acceleration system 200 employs several data structures that achieve the desired data transfer functionality. The data structures, for example, include: input data, which is the input data for the neural network layer; output data, which is the output data for the neural network layer; and model data, which includes the weights for the neural network layer. Other data structures are possible. For example, an additional data structure includes activation and scale control, which is the parameters used for activation and scale operations.

The machine learning acceleration system 200 employs descriptors that are used to transfer the various types of data. For example, as illustrated in FIG. 4, the core local memory 400 may include an input descriptor (Input Descr) 402 and a weight descriptor (Wt Descr) 406 that are used by the descriptor execution engine 232 to send the input data and the weight data, respectively, to the compute engine 240. Additionally, an output descriptor (Output Descr) 404 is used by the descriptor execution engine 232 to receive data from the compute engine 240, apply the activation function and scaling if needed, and to write the data to the local memory (local memory 224). A data out (DOUT) descriptor (DOUT Descr) 408 is used to send data from core to core or from core to the system memory 204, e.g., via the core ring 212. A main descriptor 410 is a descriptor that holds a pointer to the descriptors that are to be executed in a core 220. For example, as illustrated, the main descriptor 410 may include an input descriptor pointer (Input Descr Ptr) 412 that points to the input descriptor 402, an output descriptor pointer (Output Descr Ptr) 414 that points to the output descriptor 404, a weight descriptor pointer (Wt Descr Ptr) 416 that points to the weight descriptor 406, and DOUT descriptor pointer (DOUT Descr Ptr) 418 that points to the DOUT descriptor 408. The input descriptor pointer 412, output descriptor pointer 414, and weight descriptor pointer 416 may also have parameters that define the shape of the data. The main descriptor 410 may further include a link 419 that links to another main descriptor 410a.

Additionally, data in (DIN) descriptors, illustrated as a plurality of DIN descriptors 420a, 420b, 420c, and 420d, sometimes individually referred to as DIN descriptor 420 or collectively referred to as DIN descriptors 420, are executed in the system DMA engine 210, as opposed to the descriptor execution engine 232 in a slice, and are therefore not shown in the core local memory 400. The DIN descriptors 420 are illustrated in a number of DIN descriptor sets (DIN DESCR SET) 422. The DIN descriptor 420 may be used by the system DMA engine 210 to send data from the system memory 204 to the core local memory 400.

The DIN descriptor 420 and the DOUT descriptor 408 may include source and destination addresses along with the size of the transfer to be performed. The DIN descriptor 420, DOUT descriptor 408, and the Main descriptor 410 may be capable of linking to their own type of descriptors via a link list, e.g., link 419 shown in the main descriptor 410, and shown by the arrows linking the DIN descriptors 420 in the DIN descriptor set 422.

The basic data transfer functionality may be enabled using a plurality, e.g., three, registers 430, although any suitable number of registers can be used. For example, a system memory trigger register (SysMemTrig) 432 points to the DIN descriptor 420 to be executed and may include a trigger active bit. When the trigger active bit is set, the system DMA engine 210 fetches and executes the DIN descriptor 420 being pointed to followed by the linked DIN descriptor 420 until the associated link list is exhausted.

A core trigger register (CoreTrig) 434 points to the main descriptor 410 to be executed. As discussed above, the main descriptor 410 may include a pointer to any or all of the input, weight, output and DOUT descriptor that is to be executed. It should be understood that while FIG. 4 illustrates the main descriptor 410 as including pointers for all of the descriptors, the main descriptor 410 may include only the pointer associated with the descriptor that is to be executed, e.g., if only the DOUT descriptor 408 is to be executed, the main descriptor 410 may include only the DOUT descriptor pointer 418.

Additionally, a Core 2 System next register (C2SNext) 436 may point to a DIN descriptor 420 that is the next descriptor to be executed by the system DMA engine 210.

The compiler 256, shown in FIG. 2A, may be responsible for generating all the descriptors. Initially, all the descriptors may reside in the system memory 204. As used herein, the descriptors that are executed in the system DMA engine 210, e.g., the DIN descriptors 420, are sometimes referred to as DMA descriptors, and the descriptors executed in the core 220 in the descriptor execution engine 232, e.g., input descriptor 402, output descriptor 404, weight descriptor 406, and DOUT descriptor 408, are sometimes referred to herein as core descriptors.

As illustrated in FIG. 4, the DIN descriptors 420 may be arranged as a DIN descriptor set 422 with descriptors in a set pointing to the next descriptor in the set. Each DIN descriptor set 422 of DIN descriptors 420 are used to run the operation in a core 220. The operation, for example, may be part of a neural network layer. The SysMemTrig register 432 points to the DIN descriptor set 422 that is to be executed and the C2SNext register 436 holds the address of the next DIN descriptor set 422 to the executed.

Each DIN descriptor 420 in the DIN descriptor set 422 is responsible for sending a “type” of data to the local memory. For example, FIG. 4 illustrates four DIN descriptors, e.g., DIN descriptors 420a, 420b, 420c, and 420d in the DIN descriptor set 422. The first DIN descriptor 420a, by way of example, transfers all of the core descriptors (main descriptor and associated descriptors) to the core local memory 400. The second DIN descriptor 420b transfers the weights. The third DIN descriptor 420c writes to the C2SNext register 436 the next DIN descriptor set to be executed. The fourth DIN descriptor 420d writes to the CoreTrig register 434 to begin execution of the next main descriptor 410a. It should be understood that the DIN descriptor set 422 is merely an example and not a limitation, and that other DIN descriptors may be present or absent, for example, there may be no weight transfer or no input data sent to the core 220 depending on the neural network layer.

When the descriptor execution engine 232 in a slice 230 starts to execute the core descriptors stored in core local memory 400, the descriptor execution engine 232 writes the contents of the C2SNext register 436 to the SysMemTrig register 432 leading to execution of next DIN descriptor set 422. Thus, all of the DIN descriptor sets are functionally linked to each other.

The core local memory 400 may be organized into two (or more) sections and data may be transferred to the core local memory 400 in a distributed manner. For example, while the descriptor execution engine 232 in a slice 230 is executing descriptors from a first section of the core local memory 400, the system DMA engine 210 may transfer data to the second section of the core local memory 400, and vice-versa. By distributing the data in this manner, the latency of the external memory will have little or no effect on compute operations. The distribution of data to the sections in the core local memory 400 may be controlled by the compiler 256.

All of the above operations may be performed under the control of the compiler 256. The hardware in the system DMA engine 210 and the descriptor execution engine 232 are executing the descriptors as pointed to by the SysMemTrig trigger register 432 and CoreTrig register 434.

It should be understood that in some implementations, descriptors may be implemented as a functional description or may be simply a single bit indication. For example, a bit in the last DIN descriptor 420 may indicate to send the C2SNext pointer transfer and another bit may indicate to send the CoreTrig pointer after that. The link field may be a count indication in the first DIN descriptor. Further, the core descriptors may be executed based on a differential, e.g., using fields that indicate the difference from the previous descriptor.

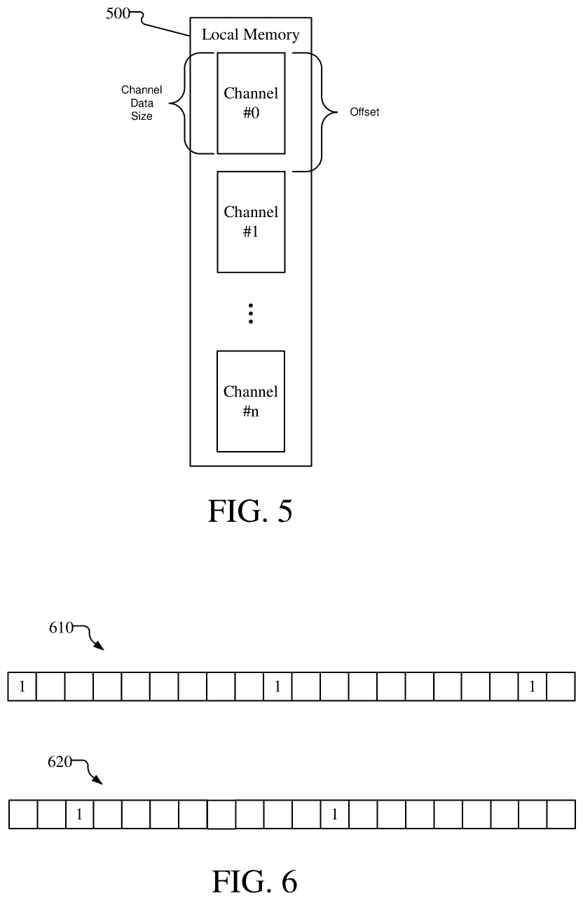

FIG. 5 schematically illustrates data stored in local memory 500 that may be used to implement basic data transfer functionality between the local memory and the compute engines within each core. Local memory 500, for example, may be local memory 224 shown in FIG. 2A or core local memory 400 shown in FIG. 4. While FIG. 5 is described in reference to machine learning acceleration system 200 illustrated in FIGS. 2A-2E, it should be understood that FIG. 4 may be applied to other machine learning acceleration systems, such as the machine learning acceleration system 300 shown in FIGS. 3A-3B.

As illustrated in FIG. 5, the data held in local memory 500, e.g., the input, output and weights data, is stored in multiple channels, identified as Channel #0, Channel #1, . . . . Channel #n, where n can be any natural number. Each channel has a channel data size and an offset. The offset indicates the space between the first data in a channel and the first data in the next channel, and is sometimes referred to as stride. The channel size is H*W of the data, where, as used herein, H is equivalent to the number of rows and W is equivalent to row length. The row offset, as used herein, indicates the location of data within a row.

As illustrated in FIG. 2B, the compute engine 240 includes the input data memory 242. The input data memory 242 is used to hold the input data that is needed for the operations in the compute engine 240, as well as the weights data. The input data memory 242 may be highly banked to allow multiple reads and writes to it.

In one example, the input data memory may be 64B+2B in size, although other memory sizes are possible. For example, there can be a need for 64B of data to feed the 64 compute hardware. The remaining 2B (two bytes) are used to hold the pad data. That optimization removes the need to send data across the slices 230 and cores 220. There may be 2B, 4B or 8B of pad data based on the data size, although other sizes of pad data are possible.

The input data memory 342 of the compute engine 340 shown in FIG. 3C may be used to hold input data channels based on the size of the memory remaining after accounting for the locations used to store the weights. The division may be determined by the compiler 356. As an example, the input data memory 342 may be 128×18B (bytes) in size, and the compiler 356 may use 64 input channels for input data and use the remainder to store the weight data, although other memory sizes and numbers of input channels are possible. Merely for purposes of illustration and not limitation, if the compute engine 340 includes sixteen sub-compute engines 344, sixteen bytes of data may be used to feed the sub-compute engines 344. The remaining two bytes of the 18B of input data may be used to hold the pad data, which removes the need to send data across the compute engines. In some implementations, there may be 2B or 4B of pad data depending on the hardware parameter, although other sizes of pad data are possible.

Common fields used across the descriptors include: the start address, which is the address of the first channel first data; the data offset, which is the space between the first data in a channel and the first data in the next channel; the CE count, which is the compute engine count to be used for the transfer; and the channel count, which is the input channels (based on the depth of input data memory 342) for input descriptor and the output channels (based on the depth of partial data memory 346) for output descriptor. The weight descriptor will have both input and output channel count. The input descriptor will also have fields including the row length (e.g., W) and row offset, which indicates the location of data within a row. These fields are used by the descriptor execution engine 322 to send a mask to the compute engine 340. The mask is used by the compute engine 340 to insert pads at the correct location. The mask, for example, is a set of bits with each bit indicating the start of the row.

FIG. 6 illustrates example data masks 610 and 620 that may be used by the descriptor execution engine 322 and sent to the compute engine 240 along with the data. The total input data used may be determined based on the CE count and the number of sub-compute engines per compute engine. For example, if there are sixteen sub-compute engines 244 in each compute engine 240, the total input data used may be determined as the CE count*16. If the CE count is one, i.e., only one compute engine 240 is used, and the frame size is 9×9 (W*H), there will be sixteen data bits used and the row offset will be seven in the second run. Thus, the first data mask 610 for the first run has a row length of nine and a row offset of zero, and the second data mask 620 for the second run has a row length of nine and a row offset of two.

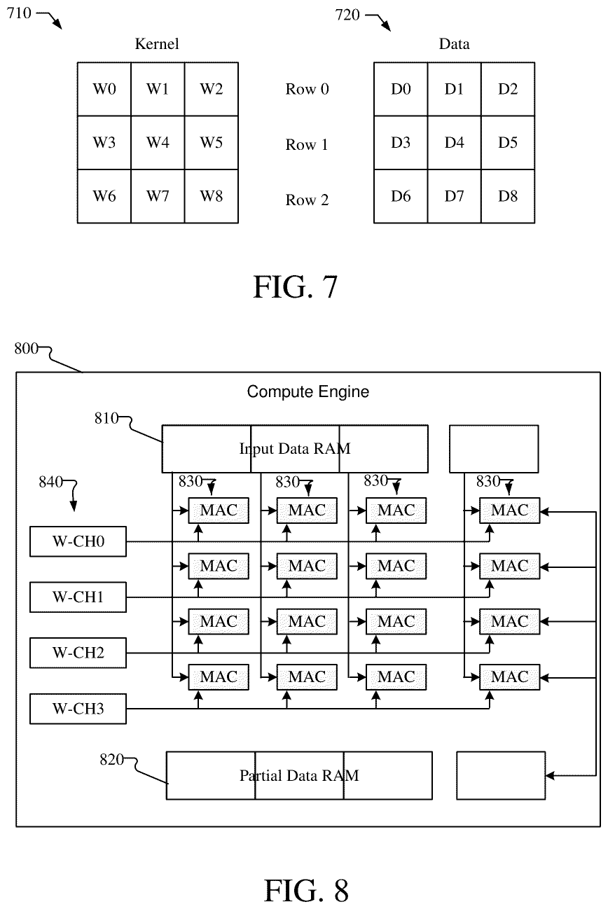

The compute engine 240 may perform all the compute operations required to handle a partial kernel if the kernel is bigger than 1×1. FIG. 7, by way of example, illustrates a 3×3 kernel 710 with weights labelled W0-W8, and 3×3 data frame 720 with data bits labeled D0-D8, with which a convolution operation may be performed. With a symmetric kernel, as illustrated by kernel 710 in FIG. 7, the center (origin) of the kernel, e.g., with weight W4, is placed on a current pixel on the data frame 720, and the weight of each kernel element is multiplied with the value of the pixel that it overlaps in the data frame 720, and all of the obtained values may be summed to produce the new value for the current pixel, i.e., the pixel in the data frame 720 overlapped by the center (origin) of the kernel. Using the nomenclature illustrated in FIG. 7, when the kernel 710 is centered on the data frame 720, i.e., the center of the kernel 710 (with weight W4) overlaps the center of the data frame 720 (with data bit labeled D4), the output of Row 0 may be written as Row0 output=W0*D0+W1*D1+W2*D2. The output of Row 1 may be written as Row1 output=W3*D3+W4*D4+W5*D5. The output of Row 2 may be written as Row2 output=W6*D6+W7*D7+W8*D8. The final output and new value for the pixel at the center of the data frame 720 is the sum of the outputs from Row 1, Row 2 and Row 3, i.e., Final Output=Row0 output+Row 1 output+Row2 output.

The sub-compute engines 244 may perform the calculations on a row-by-row basis and store the output of each row in the partial data memory 246. The input descriptors generated by the compiler 256 will first transfer the Row0 input and corresponding weights, followed by the Row 1 input and corresponding weights, followed by the Row2 input and corresponding weights. The compute engine 240 generates partial data for all the output channels that can be stored in the partial data memory 246, indicated by the output descriptor.

The compute engine 240 generates the partial output for one row at a time. The extra pad data (e.g., the 2B input data) and the mask may be used to assist this process.

In the above example, the row length is nine, the CE count is one, and 16 sub-compute engines are used. For the first set of input descriptors generated by the compiler 256, the Row0 input data and corresponding weights are transmitted. The first descriptor includes data XX+D0-D15+D16 that is sent to a compute engine 240, where XX represents unused data and D16 is the 17th data bit (8th data bit in the second row). The data D16 is needed to calculate the output from the 16th sub-compute engine 244 from the compute engine 240. The compute engine 240 uses the mask to insert pad data at the correct location.

The compute engine 240 replaces XX, D8, and D17 with the pad data and calculates W0*D0 for all 16 outputs. The compute engine 240 then removes all the pad data, and uses D0-D15 to calculate W1*D1, accumulating with the previous results. Finally, the compute engine 240 replaces D9 with pad data and uses D1-D16 as input and calculates W2*D2. The final accumulated data is stored in the partial data memory 246. This operation generates the row0 partial data for the output channel.

In the second set of input descriptors generated by the compiler 256, the Row1 input data and corresponding weights are sent with compute engine 240. The compute engine 240 calculates the Row1 output in a similar manner as the Row0 output discussed above, and accumulates the Row1 output with the Row0 output. The process is repeated for Row2, e.g., with the third set of input descriptors generated by the compiler 256 including the Row2 input data and corresponding weights, which are sent with compute engine 240, which determines the Row2 output in a similar manner discussed above, and accumulates the Row2 output to produce the final output.

If there are more input channels, the Row2 stays in the partial data memory 246 in the compute engine 240 and a second set of input descriptors transfer the next set of input data and the computation is completed.

On the final set of input descriptors/channels the partials are sent back to the descriptor execution engine 232 for activation function and then stored back to the local memory 224.

In some implementations, if there are 64 sub-compute engines in the compute engine, 4 input channels may be simultaneously operated on for convolution operations. In the case of depth-wise operations, four input channels and four output channels may be simultaneously computed.

This method of operation keeps the input data local to the compute engine 240 and reduces the need for reading and writing to the local memory 224 multiple times. The compute engine 240 may send only the final partial data back to the local memory 224.

If the input data memory 242 is 18B, that optimizes up to 3×3 kernel. Larger kernels may also use this method to implement any size kernel.

This process may be used to insert “any” size pad where the mask is specified. The input data descriptor specifies the row length for the hardware to generate the mask and then inserts the appropriate size of mask bits. The input hardware descriptor also specifies the number of top/bottom pad to send to the compute engine 240.

For the machine learning acceleration system 300 shown in FIGS. 3A-3C, in Mode 0 operation, the input data is sent over the data ring 334 to the input data memory 342, and the weight data is sent over the broadcast bus 332. The output from the compute engine 340 is returned over the data ring 334 back to the descriptor execution engine 322.

For Mode 1 operation, the input data frame size will be much smaller than the compute length in each compute engine 340, i.e., CE count (number of compute engines) times the number of sub-compute engines per compute engine (CE Count*16 (if 16 sub-compute engines per compute engine are used)). In Mode 1 operation, the input data is sent over the broadcast bus 332 and weights are sent over the data ring 334 and stored in the input data memory 342. Each compute engine 340 can then generate 16 output channels and all of the compute engine can be used if the number of output channels is greater than total input data size (e.g., CE Count*16), which will be the typical case with small input data frame size. The Mode 1 operation may be used, for example, for fully connected neural network layers and matrix multiplication operations.

For Mode 2 operation, the input data frame size will be larger than 1×1, but smaller than the total input data size, i.e., CE count (number of compute engines) times the number of sub-compute engines per compute engine (CE Count*16 (if 16 sub-compute engines per compute engine are used)). In Mode 2 operation, each compute engine 340 is logically split by the compiler 356 into groups, where each group creates a separate set of output channels. Accordingly, the same input data may be sent to each group of a compute engine 340 over the data ring 334, and each group receives a different set of weights over the broadcast bus 332.

Mode 3 operation may be used to improve utilization for depth-wise cases that have a small frame size and large channels. In Mode 3 operation, similar to Mode 2 operation, each compute engine 340 is logically split by the compiler 356 into groups, where each group creates a separate set of output channels. In Mode 3 operation, however, different input data is sent to each group of a compute engine 340 over the data ring 334.

In some implementations, the compute engines 340 may be configured to perform additional operations using the data stored in the input data memory 342 and storing data in the partial data memory 346. For example, in some implementations, the compute engines 340 may perform element-wise multiplication, addition, and subtraction. In some implementations, the compute engines 340 may perform an average pool layer operation to add all elements. In some implementations, the compute engines 340 may perform comparison operations. In some implementations, the compute engines 340 may perform integer division approximation via multiplication and division.

Efficient data transfer between cores 320 is desirable during multi-core operations. When multiple cores 320 are present, the core 320 closest to the system DMA engine 310 may be treated as the master core. The master core may be responsible for synchronization across all the cores.

With multiple cores 320 there may be two modes of operation, such as, for example, a frame mode and a channel mode. In both modes, all the cores 320 will perform the same amount of calculations and also work on the same set of addresses. Accordingly, all of the descriptors may be broadcast by the system DMA engine 310 to all the cores 320 and a trigger is also broadcast to all of the cores 320.

In frame mode, the input data frame may be split evenly across all the cores 320. In this mode, all the cores 320 have the exact same model data that is broadcast across the cores 320. In this mode, the cores will transfer top and bottom rows initially, if the operation involves a kernel larger than 1×1. Frame mode, for example, may be selected to be used by the compiler 356 when the frame size is large.

In channel mode, the frame size may not be large, but the number of output channels is large. In the channel mode, the same data is present in all the cores 320 and they all generate different sets of output channels. At the end of the operation, all the cores 320 broadcast all channels to each other so that all the cores 320 have the exact same data to start processing the next layer.

For synchronization, the C2SNext value stored in the C2SNext register 436 is sent from the core 320 to the system DMA engine 310 when all the cores 320 have completed execution. Core0, e.g., the core closest to the system DMA engine 310, is used for the synchronization. Core0, for example, may hold a done bit for each core 320. Once the done bit it set for all the cores 320, the C2SNext value stored in the C2SNext register 436 in Core0 may be sent to the system DMA engine 310.

Referring back to the compute engine 240 shown in FIG. 2B, in one example, the input data bus 236 may be 72B+72b, e.g., where the 72B are 64B of data+8B of pad, and the 72b are the mask bits. The input data memory 242 may hold the input data and weights sent by the descriptor execution engine 232. The input data is split into data+pad+mask. The pad data is to account for pads for greater than 1×1 kernel, and the mask indicates the start of row (column 0).

Each input channel may generate up to four, eight or 16 output channels in a cycle, although other suitable numbers of output channels are possible. The input data may be 64Bx4ch or 32Bx8ch or 16Bx16ch, although other input data sizes are possible. Merely for purposes of illustration and not limitation, 64Bx4ch means that the input data is 64B used to generate four output channels in a cycle, whereas 32Bx8ch has 32B of input data used to generate eight output channels in a cycle, and 16Bx16ch has 16B of input data used to generate sixteen output channels in a cycle.

The partial data memory 246 may store up to 256 pieces of data, each 32b wide. The accumulated data is 32b wide for BFloat16 and Int8, and it is 40b or 48b (selectable by software) for Int16 data. Other data sizes are possible.

The weights bus 234 is 32B wide to allow for double buffer, because, in the 16 output channels case, compute consumes 16B of weights each cycle. Accordingly, in that case, the weights bus 234 needs to be loaded every other cycle to keep the compute busy or otherwise sufficiently loaded. Other widths for the weights bus 234 are possible.

The output data bus 238 is 512b wide and may carry 16 channels in each cycle when the final calculation is 32b wide. Other widths for output data bus 238 are possible.

FIG. 8 illustrates the data flow within a compute engine 800 for 64Bx4ch input data, in accordance with one implementation. The compute engine 800, for example, may be used as the compute engine 240 illustrated in FIGS. 2A and 2B. Compute engine 800, for example, includes input data memory (RAM) 810 that, in this example, is 64B wide, and partial data memory (RAM) 820 that, in this example, is 64*4Bx8ch, i.e., the partial data memory 820 can hold 64B*4B of partial or output data for eight channels. The partial data is 64B*4B to account for accumulation, i.e., each data is 4B wide. In this example, the input data may have Int8 format.

As illustrated, the compute engine 800 includes a number of sub-compute engines 830. By way of example and not limitation, the compute engine 800 may include 64 sub-compute engines, e.g., MAC, in each row, and may include four sub-compute engines, e.g., MAC, in a column, for a total of 256 operators. Each column may be a set of sub-compute engines, e.g., MAC. The same input data is sent to a set of, for example, four MAC in a column, although a column can include greater or less than four MAC. A set of weights 840 is sent to the MAC along a row for each channel. Each set of MAC generates one output channel of partial or output data in a cycle. Accordingly, there are four output channels generated in each cycle. In the next cycle, the next four output channels of partials are generated. If there are more input channels, the input data memory 810 and weights are updated to the next channel and computing continues until the final input channel is used to generate the final output data.

When the final output data has been generated, it is sent to the descriptor execution engine 232, shown in FIG. 2A, for activation and scaling. For local memory bandwidth utilization, the partial data is not sent to the local memory 224 in FIG. 2A. With this mechanism, the input data is read multiple times if the number of output channels is larger than 8. In this implementation, if the output channels are not a multiple of four, however, this will lead to utilization loss on the final output generation.

For grouping functionality, the input data may be duplicated on the 64B input data bus 236, shown in FIG. 2B. For example, if there is 32B of data, the data is duplicated once (32B (original)+32B (duplicate)=64B) and, in 16B case, data is duplicated three times (16B (original)+16 (dup1)+16 (dup2)+16 (dup3)=64B). To generate a higher number of output channels, different sets of weights 840 are sent to the duplicated data. For example, assuming the input data is 32BX8ch, the output is still 64Bx4ch, but in each cycle the 64B carries two sets of output channels, thereby generating eight output channels. Accordingly, in the four output channels case, the compute consumes four weights 840 in each cycle, whereas in the eight output channels case, eight weights are consumed in each cycle, and in the sixteen output channels case, 16B are consumed in each cycle.

For the case of 32Bx8ch input data, the only change is that the input data is duplicated via descriptors in the input data memory 810 and twice the number of weights 840 are sent, e.g., one weight for each channel. In the 16Bx16ch input data case, however, the local memory 224 (in FIG. 2A) is heavily utilized. The weights and input data are fetched every other cycle. If the number of input channels is two or less, the output is also sent to local memory 224 every other cycle. Accordingly, the local memory 224 may be banked. The compiler 256 may ensure that the weights, input, and output data are aligned for maximum bank utilization. The ideal alignment, for example, is for the data to be aligned to 64B boundary.

While FIG. 8 and the above explanation assumes MAC operation in the sub-compute engines 830, the description for elementwise or even bypass operations may be used, e.g., where the weights bus 234 carries one of the elements if required and there is no partial data.

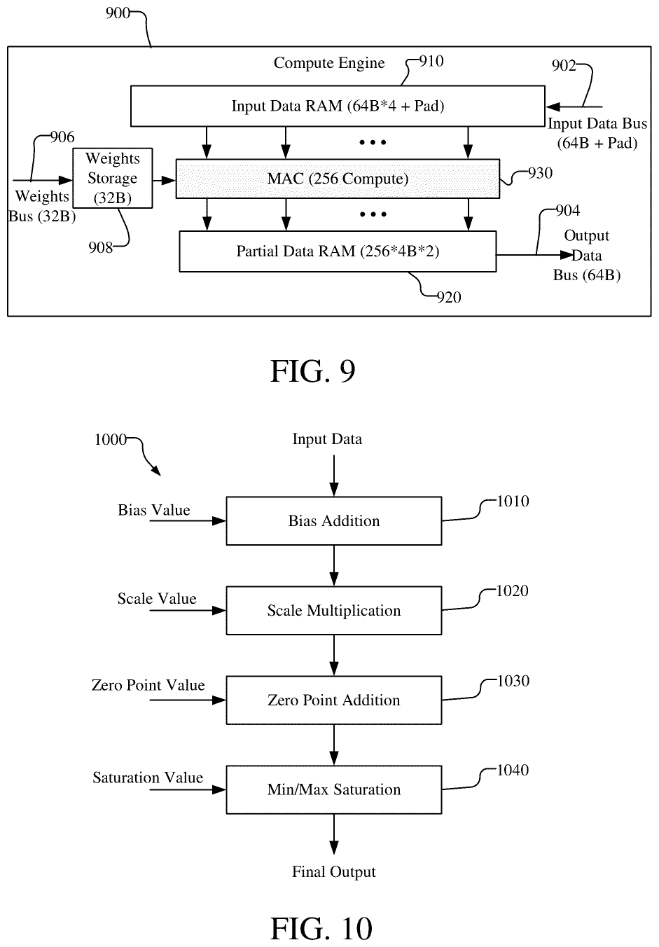

Merely for purposes of illustration and not limitation, FIG. 9 illustrates a compute engine 900 with sizes for the input data bus 902, output data bus 904, weights bus 906, and storages in the input data memory (RAM) 910 and partial data memory (RAM) 920, and the size of the sub-compute engine 930, which may include MAC. The compute engine 900, for example, may be used as the compute engine 240 illustrated in FIGS. 2A and 2B. The input sizes are for data only in this example for the sake of simplicity, i.e., pad data is not included.

The input storage, e.g., input data memory 910, may be organized as a buffer of four, i.e., in each cycle 64B may be consumed typically. In typical convolution runs, the input storage is maximally used as double buffered.

The weights bus 906 and weights storage 908 may be 32B wide. In the 64Bx4ch case, four weights are consumed in each cycle, and in the 32Bx8ch case, eight weights are consumed in each cycle, and in the 16Bx16ch case, sixteen weights are consumed in each cycle. Accordingly, in the worst case, the weights storage 908 is double buffered, which allows for a gap in the weights delivery to the compute engine 900 without reducing performance.

The partial storage, e.g., partial data memory 920, may store 256 partials in each cycle-one from each MAC. The partials stored may be four channels, eight channels or sixteen channels in each cycle, although other channel sizes are possible. The partial storage may be organized as double buffered. Accordingly, in cases when partial storage needs to be sent to descriptor execution engine 232, shown in FIG. 2A, as final computation, the second buffer is utilized by the compute engine 900 for the next set of output channels.

In cases when the weights are sent on the weights bus 906, for convolution, as opposed to depthwise operation, the following operations may be performed. In each cycle, one “set” of output channels are generated using one input channel. The same input channel is used to create the next “set” of output channels. In other words, the input data may be sent every other cycle (1×1 kernel) to keep the compute busy or otherwise sufficiently loaded. The input data memory 910 has multiple buffers to allow for the next data to be sent in, which allows the local memory 224 (shown in FIG. 2A) to “miss” some cycles due to bank conflicts without leading to utilization loss.

Similarly, the weights are needed every other cycle in the 16Bx16ch case. In other cases, the weights bus 906 has less bandwidth requirements.

In cases where there are only two input channels, the output is ready every other cycle. Similarly, the output is ready every cycle when there is only one input channel and kernel size is 1×1. For higher kernel sizes, the output takes multiple cycles to be ready as explained previously. For example, in a 3×3 kernel case, even for one input channel, the output is ready every three cycles. Accordingly, in typical cases, the output data bus 904 could be a bottleneck.

The local memory bandwidth is important to feed the input data memory 910, as that is consumed every cycle in 1×1 kernel case. In a 3×3 kernel case, the input data is consumed every 3 cycles for convolution.

Additionally, to reduce the latency of the system memory 204, shown in FIG. 2A, the local memory 224 may be utilized as a ping pong buffer for data fetched from the system memory 204 for maximum efficiency to hide the system memory 204 latency, e.g., the next data is being fetched while the current compute is in progress.

The number of channels to process in each fetch operation decides the number of cycles of latency that can be absorbed. For example, in convolution cases, the number of cycles to compute the output is (frame size/64)*input channel count*kernel size*output channel count. Accordingly, for a modest input channel count*output channel count of 16*32, even with kernel size of 1×1 and small frame size, the system can consume system memory 204 latency of 512 cycles. If the frame size is large, a smaller number of channels worth of kernel fetch would keep the compute busy or otherwise sufficiently loaded. If the frame is small and the number of channels is also less, multiple layer models can be fetched at a time.

There may be instances when the compute might be limited due to data availability or bus bandwidth. By way of example, in depthwise operation or elementwise operations, the number of outputs is the same as the number of inputs, leading to saturation of the output data bus 904. In most cases, this may result when the number of input channel is not large or is one. The maximum utilization achieved in these cases is 25%, as not all four parallel compute can be utilized. With only one set of output channel, the output bus sends data every cycle. This utilization degradation is acceptable in most cases as the depthwise or elementwise operations do not represent the majority of the compute. In the depthwise computation, the output is not sent every cycle, as usually the depthwise is either 3×3 or 5×5 kernel. With a larger kernel, there is an additional optimization that may be performed to improve the utilization, e.g., such as when the kernel is bigger than 1×1 for depthwise operations. In the depthwise case, the row0, row1, and row2 are calculated in parallel in each of the three (out of four) compute rows, e.g., as illustrated in FIG. 7. Accordingly, multiple weights for the single channel are sent. For example, instead of W-Ch0 (as illustrated in FIG. 8), W0-Ch is sent; instead of W-Ch1, W1-Ch is sent; and instead of W-Ch2, W2-Ch is sent. In the 3×3 case, the output is available every three cycles and compute utilization is 75%. The compiler 256 (shown in FIG. 2A) may reformat the weights in the format required by the compute engine 900.

In another example, in fully connected or matrix multiplication, the model data is consumed at a large rate and is not reused, as discussed below with respect to dense mode operation and matrix multiplication section. In these cases, the compute is limited by the amount of model that is fetched from the system memory 204 per cycle. For example, a suitable integrated circuit (e.g., a member of the Astra family of AI-Native IoT processors available from Synaptics Incorporated or the like) can have eight 8b weights received in each cycle. If eight weights are consumed in each cycle, the compute will not be fully utilized and will be limited by the system memory 204 bandwidth.

As noted above, the machine learning acceleration system 200 may use various data formats. For example, in some implementations, the baseline data format may be Int8, where all functions are supported at maximum compute utilization for Int8 operations. The machine learning acceleration system 200 may also support Int16 input data and BFloat16input and weights data. In the Int16 input case, the partial data may be 40b or 48b (selectable) wide. In the BFloat16input data, the partial data is Float32 in size.

Many factors determine the maximum utilization. Bus sizes and associated bus bandwidth, for example, are one of the factors. In the example illustrated in FIG. 9, the input data bus 902 to the compute engine 900 is 64B (plus pad data) wide. Accordingly, when the input data is 8b wide, all the 64 parallel computes (64 MAC in row W-Ch0 in FIG. 8) can be utilized. But in the case of Int16 and BFloat16, the input data is 16b wide so the input data bus 902 may only carry half the data, leading to 50% utilization.

The descriptor execution engine 232, shown in FIG. 2A, may perform computations. For example, final partial data may be sent to the descriptor execution engine 232. The descriptor execution engine 232 may perform the activation and scaling, and may write the data back to local memory 224. The descriptor execution engine 232 may hold sixteen, or other scalable number, of activation units per compute engine 240. Data that is sent to the descriptor execution engine 232 from the partial data memory 246 may be sent in ping pong mode or in one shot. In ping pong mode, for example, four channels of output may be generated and sent to the descriptor execution engine 232. While the descriptor execution engine 232 is operating on activation of the data, the next four output channel calculations may be performed by the sub-compute engines 244. For smaller frame sizes, e.g., 32Bx8ch or 16Bx16ch modes, the input data is smaller in size and more output channels are generated and received by the descriptor execution engine 232. The data control, for example, may be via descriptors that are running in the descriptor execution engine 232.

For activation and scaling function operations in the descriptor execution engine 232, each descriptor execution engine 232 may instantiate sixteen (or less) activation function. The activation and scaling function implemented by the descriptor execution engine 232 may be similar to Rectified Linear Unit 6 (RELU6), but it is flexible enough to implement other activation functions coupled with the gather or table operations. For example, the activation function gets 32b input and produces Int8 for Int8 operations. For Int16, it can take in 40b or 48b input and produce Int16 output. For BFloat16, no scale operation is performed. The parameters (e.g., bias, scale, zero point addition, and max/min saturation values) for activation are fetched from the system memory 204 by descriptors.

FIG. 10 illustrates the operation of each activation function 1000 performed by a descriptor execution engine 232, in some implementations. The descriptor execution engine 232 may receive input data from the partial data memory 246 and may receive bias, scale, zero point, and saturation values from the system memory 204.

As illustrated, the descriptor execution engine 232 receives input data and a bias value and performs bias addition (1010). Using the scale value, the descriptor execution engine 232 then performs scale multiplication (1020). Using the zero point value, the descriptor execution engine 232 then performs zero point addition (1030). Further, using the saturation value, the descriptor execution engine 232 performs the min/max saturation (1040) to produce the final output.

Activation and scale functions are typically implemented in hardware for use cases that use RELU6. However, with the flexible hardware in the compute engine 240 and with the gather and table operations, any activation function can be implemented on machine learning acceleration system 200.

As discussed above, when the input data frame size is small, the compiler 256 may send weights and input data via the weights bus 234 to the input data memory 242 of the compute engine 240 in dense mode. In dense mode, the frame size may be much smaller than, for example, 64B. For example, in one dense operation, the input data may be 1×1 frame size. If that input data is stored in the input data memory 242, the utilization would be 4B computed out of 256B. The number of weights, however, is large in those cases. Accordingly, the compiler 256 will switch to dense mode. The compiler 256, for example, may switch to dense mode when the input data frame is less than, for example, 8B.

In dense mode, the input data is sent over the weights bus 234 and the weights are sent over the input data bus 236 and are stored in the input data memory 242. Each compute engine 240 may then theoretically generate, for example, 256 output channels. If the frame size is 1×1, however, the weights are used only once, so weights fetch from the system memory 204 would typically be the limiting factor. If the frame size is 2×2, for example, then the weights are used four times and utilization would be higher.

In one implementation, the basic operation mode will run with low utilization in fully connected layers or dense layer if the input data has a 1×1 frame size. For a fully connected layer, the input data memory 242 may store the weights. Input data is sent over the weights bus 234. The data goes through a transpose operation before layer operations. The sending of input data or weights over different buses may be selectable, e.g., via software.

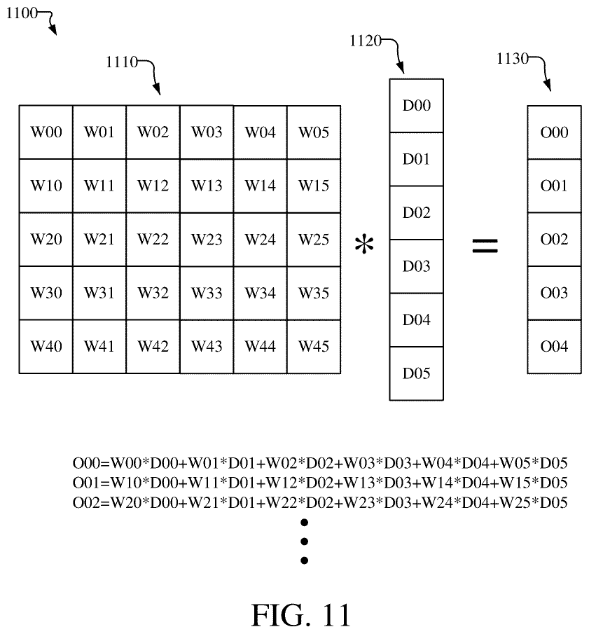

By way of example, FIG. 11 is a diagram illustrating a fully connected layer operation 1100. The weights 1110 are sent over the input data bus 236 after transpose by the compiler 256 to the input data memory 242. The data 1120 is sent over the weights bus 234. In operation, Wx0 (e.g., where “x” refers to numerals 0-4, i.e., W00, W10, W20 . . . ) is sent first and put into an accumulator, followed by Wx1 (e.g., W01, W11, W21 . . . ), etc., to generate the output 1130, as illustrated. The compiler 256 may switch to using the dense mode if the frame size is smaller than, for example, 8B. With the frame size of 8B and using 16Bx16ch configuration, the utilization is 50% and does not require any transpose operation on the data. The dense mode achieves greater than 50% utilization for smaller than 8B frames, limited by the weights fetch bandwidth on the system memory 204 interface.

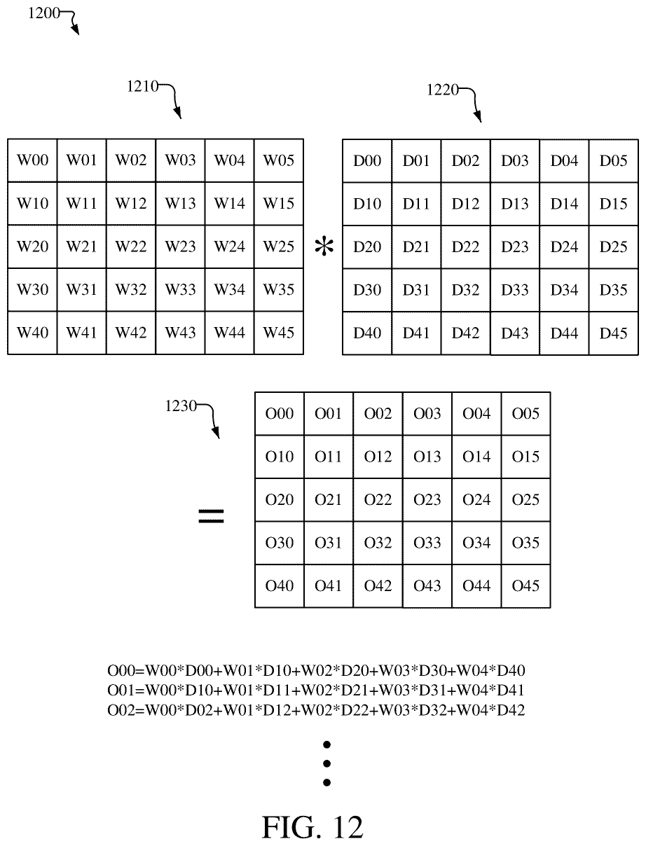

By way of example, FIG. 12 is a diagram illustrating a matrix multiplication operation 1200. The weights 1210 are sent over the weights bus 234 and the data 1220 is sent over the input data bus 236 to the input data memory 242. In operation, the weight W00 is sent first and results are put into an accumulator, followed by weight W01, etc., to generate the output 1230, as illustrated.

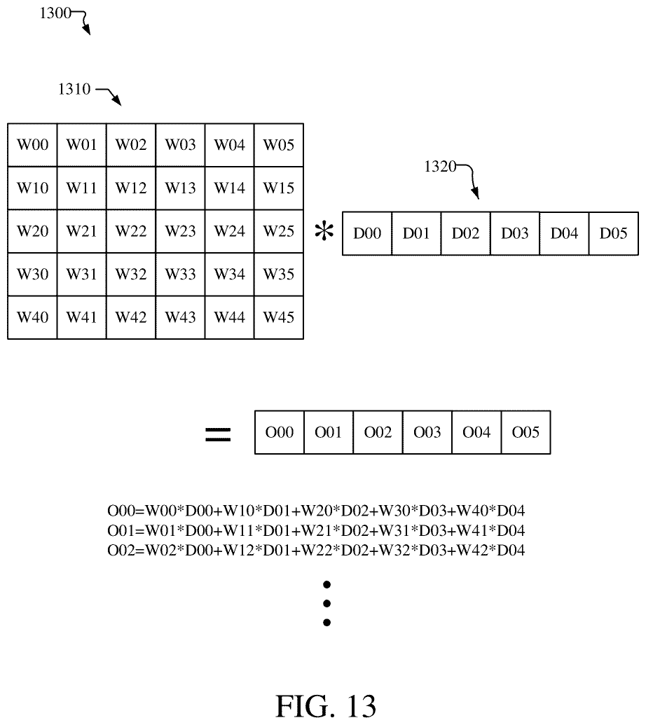

The matrix multiplication may have different dimensions than as shown in FIG. 12. For example, FIG. 13 is a diagram illustrating another matrix multiplication operation 1300. In this example, the same operation as dense mode may be performed. Thus, weights 1310 are sent over the input data bus 236 to the input data memory 242, and the data 1320 is sent over the weights bus 234. With the configuration shown in FIG. 13, however, neither the weights 1310 nor the data 1320 go through a transpose operation.

In some language model use cases, as well as in other types of models, block quantization is used for matrix multiplication (MatMul) operations to reduce the model size. In the case of block quantization, the weights are scaled down to, for example, 4b or even 2b. Consecutive weights are split into blocks and a scale and potentially zero point value is specified with each block.

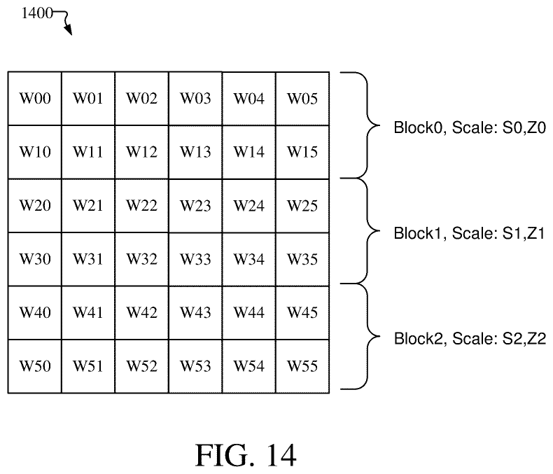

By way of example, FIG. 14 is a diagram illustrating block quantization 1400 for weights, which may be used with the machine learning acceleration system 200, in accordance with some implementations. In the example shown in FIG. 14, the weights are divided into three blocks with twelve weights in each block, but other block sizes that are a power of two, may be used. The weight to be used is calculated (dequantized) by multiplying each weight with the corresponding scale value and adding the zero point value, which produces a full weight to be used in the calculations.

The weights may be de-quantized, e.g., in a separate slice if available, and then the matrix multiplication operation is performed. For example, the de-quantization may be performed in a first slice, which sends the results to the local memory 224, which then sends the results to a second slice. The weights may be in consecutive locations for efficient scaling operation in the slice. The weights after dequantization should be sent to the input data memory 242 with the data on the input data bus 236.

In the dense layer and matrix multiplication, the memory bandwidth needed to keep the compute busy is high. For example, if the system can use 64 MAC per cycle, then 64 weights per cycle are needed. If the weights are 8b wide, then a 512b wide system memory 204 interface is needed, which may not be practical. Accordingly, the dense layer and matrix multiplication layers may be limited in compute utilization by the memory bandwidth. Without block quantization, a suitable integrated circuit (e.g., a member of the Astra family of AI-Native IoT processors available from Synaptics Incorporated or the like) would be able to utilize eight MAC per cycle. With block quantization and one slice handling the dequantization operation and another slice performing matrix multiplication, the integrated circuit would be able to utilize sixteen MAC per cycle.

The compiler 256 may store the weights for the matrix multiplication and dense layers into the local memory 224 opportunistically in previous layers to increase the MAC utilization.

There may be computations, however, where the weights might not be arranged in optimal fashion for dequantization. For example, in the fully connected layer case, the weights are transposed by the compiler 256 to achieve higher utilization. But after transpose, the weights are not in correct order for efficient dequantization operation. In such cases dequantization of transposed weights may use the stride in the descriptor that fetches the scale values from the memory.

The machine learning acceleration system 200 may use multi-slice operation with small data size. For example, when the frame size is bigger than 1×1 but smaller than 64, the slices 230 may be logically split by the compiler 256 into groups. Each group of slices may create a separate set of output channels. In this case, the same input data is sent to each group of slices from the local memory 224. Each group of slices receives a different set of weights over the weights bus 234.

The use of multi-slice operation may be used for convolution and depthwise operations, where the reuse of weights for operations on the data provides additional system memory 204 bandwidth.

In some cases, however, SL261X a system may not have enough memory bandwidth to support even convolution and depthwise operations for a small frame size. For example, if the frame size is 4×4, each slice 230 may consume sixteen weights with 16Bx16ch setup in a cycle, whereas the integrated circuit can only support 8 weights in each cycle from the system memory 204 bandwidth perspective. In such cases the compiler 256 may split the model into non-memory intensive and memory intensive operations and run the different operations on different slices via multi-tasking.

The machine learning acceleration system 200 may support various formats and operators. For example, the machine learning acceleration system 200 may natively support Int8 and BFloat16 formats for model precision. The activation data post quantization and scaling may be stored in Int8, Int16 or BFloat6 format. Further, the machine learning acceleration system 200 may support any suitable number of operators. By way of example, a list of operators that may be supported natively in the hardware for Int8 precision may include, but is not limited to, for example, CLAMP, ADD, ARITHMETIC_RIGHT_SHIFT, BITWISE_AND, BITWISE_OR, BITWISE_XOR, LOGICAL_AND, LOGICAL_LEFT_SHIFT, LOGICAL_RIGHT_SHIFT, LOGICAL_OR, LOGICAL_XOR, MAXIMUM, MINIMUM, MUL, TABLE, ABS, LOGICAL_NOT, EQUAL, GREATER, GREATER_EQUAL, PAD, GATHER, SCATTER, and RESCALE. In another example, a list of operators that may be supported via derivation using the natively supported operations and the CSS 260, which may be a RISC-V microprocessor, embedded in the core 220 may include, for example, ARGMAX, AVG_POOL2D, CONV2D, CONV3D, DEPTHWISE_CONV2D, FULLY_CONNECTED, MATMUL, MAX_POOL2D, TRANSPOSE_CONV2D, SIGMOID (floating point only), TANH (floating point only), SUB, BITWISE_NOT, EXP (floating point only), LOG (floating point only), NEGATE, RECIPROCAL (floating point only), RSQRT (floating point only), SELECT, REDUCE_ALL (logical AND), REDUCE_ANY (logical OR), REDUCE_MAX, REDUCE_MIN, REDUCE_PRODUCT (floating point only), REDUCE_SUM, CONCAT, RESHAPE, REVERSE, SLICE, TILE, TRANSPOSE, RESIZE (NEAREST_NEIGHBOR, BILINEAR), CAST, and IDENTITY. Other operators are possible.

With the gather and table support, all single input operators may be implemented on the machine learning acceleration system 200. With Int8, the table size is a 256B entry. With BFloat16 input and BFloat16 output, the table size would be 128 KB. As an example, to implement a division operator, the compiler 256 may implement reciprocal via gather operations, followed by the multiplication operation, which is directly supported on the hardware.

The machine learning acceleration system 200 may support smaller sizes of models (e.g., 2b, 4b, 6b). For example, the machine learning acceleration system 200 may support sign extension of weights on the weights bus 234 and input data bus 236 to support small weights sizes. For example, once the weights are fetched from local memory 224, the weights can be sign extended to, for example, 8b before being used in the compute engine 240, which is different than the use of block quantization, discussed above.

The machine learning acceleration system 200 permits host operation by the processor 250. For example, the host operation by the processor 250 may be able to access the local memory 224 via the interface 202, which allows the processor 250 to also operate on the data in the local memory 224.

Additionally, the descriptors sending data from the local memory 224 to the compute engine 240 should support fill operation.

Apart from utilization loss due to small frames and limited memory bandwidth to fetch the weights, there may be utilization loss due to “odd” frame sizes. For example, if the frame size is 7×7, the utilization in each slice will be ˜76%. Similarly for a frame size of 5×5 the utilization would be ˜78% with 32Bx32ch setup. For frame sizes that are larger, the compiler 256 should employ the 16Bx16ch or 32Bx8ch method. For example, if the frame size is 96B, employing 64B+32B would result in utilization of 75% but employing 32Bx8ch would result in 100% utilization.

Additionally, the convolution process may operate using stride greater than one. For example, to optimize the convolution operation when the stride is two or three or four, the input may be split into multiple segments. The segmented data may be separately sent to the compute engine as the input data.

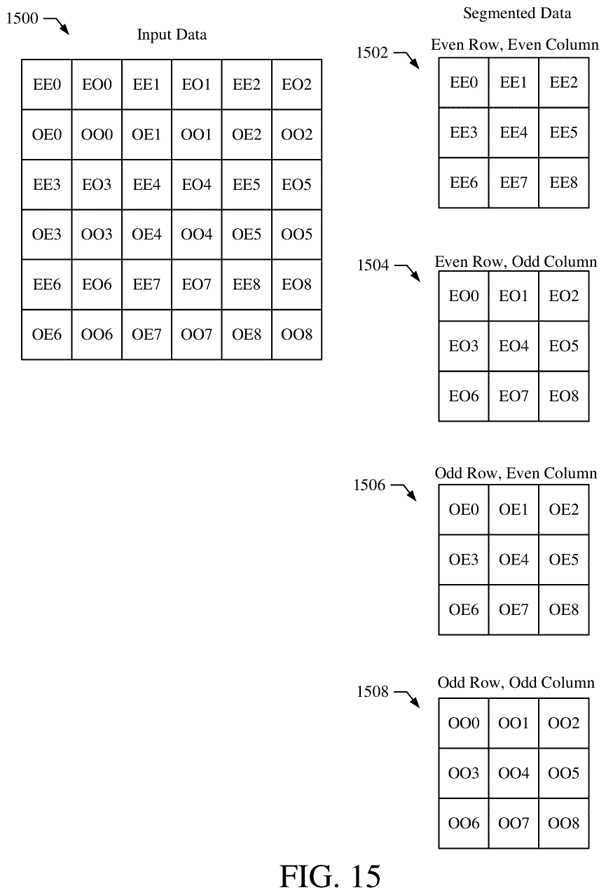

By way of example, FIG. 15 illustrates input data 1500 with which a convolution operation with the stride of two or four is to be performed. FIG. 15 further illustrates that the input data may be split into four groups of segmented data including: segment 1502 including {even rows, even columns}; segment 1504 including {even rows, odd columns}; segment 1506 including {odd rows, even columns}; and segment 1508 including {odd rows, odd columns}. If the convolution operation uses a stride of three, the input data may be similarly split into nine segments.

With the data segmented, the input descriptor may send one segment at a time to do only the required calculations. By way of example, the calculations may be performed by sending each row from each segment and the corresponding weights separately and performing the calculation and accumulating. For example, the operation may be performed in the following order. First, send the first row of segment 1502 {even row, even column} with weights W0 and W2, and calculate EE0*W0+EE1*W2 as partial. Second, send the first row of segment 1504 {even row, odd column} with weight W1, and calculate EO0*W1 as partial and accumulate. Third, send the first row of segment 1506 {odd row, even column} with weights W3 and W5, and calculate OE0*W3+OE1*W5 as partial. Fourth, send the first row of segment 1508 {odd row, odd column} with weight W4, and calculate 000*W4 as partial and accumulate. Fifth, send the second row of segment 1502 {even row, even column} with weights W6 and W8, and calculate EE3*W6+EE4*W8 as partial. Sixth, send the second row of segment 1504 {even row, odd column} with weight W7, and calculate EO3*W7 as partial and accumulate. The operation continues in a similar manner.

The segmented data may be used to implement a max pool operation as well. For example, for a 2×2 max pool, the maximum value may be determined by comparing the segments. The hardware may support stride=2 and stride=3. In a stride=3 case, the input data may be split into nine segments.

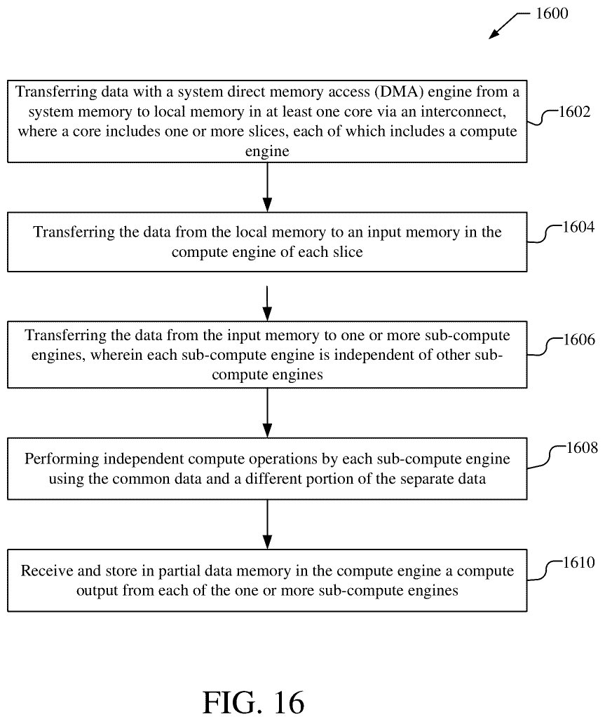

FIG. 16 shows an illustrative flowchart depicting an example operation 1600 for performing machine learning acceleration as discussed herein. In some implementations, the example operation 1600 may be performed using the machine learning acceleration system 200 shown in FIGS. 2A-2E, or the machine learning acceleration system 300 shown in FIGS. 3A, 3B, and 3C.

As illustrated, at block 1602, data is transferred with a system direct memory access (DMA) engine from a system memory to local memory in at least one core via an interconnect, where a core includes one or more slices, each slice includes a compute engine. For example, as illustrated in FIGS. 2A, 2C and 3A, the system DMA engine 210, 310 may provide a multiplexed direct communicative coupling between the system memory 204, 304 and each core 220, 320 via the interconnect 212, 312, which may have a desired topology such as a star, mesh, bus, tree, or ring.

At block 1604, the data is transferred from the local memory to an input memory in the compute engine in each slice. For example, as illustrated in FIGS. 2A, 2B, 2C, 3A and 3C, the local memory 224, 324 transfers data to the input data memory 242, 342 in each compute engine 240, 340.

At block 1606, the data is transferred from the input memory to one or more sub-compute engines, where each sub-compute engine is independent of other sub-compute engines. For example, as illustrated in FIGS. 2A, 2B, 2C, and 3C the data is transferred from the input data memory 242, 342 to the sub-compute engines 244, 344 in each compute engine 240, 340.

At block 1608, independent compute operations on the data are performed by each sub-compute engine. For example, as illustrated in FIGS. 2B and 3C, each sub-compute engine 244, 344 performs an independent compute operation.

At block 1610, a compute output from each of the one or more sub-compute engines is received and stored in partial data memory. For example, as illustrated in FIGS. 2C and 3C, each compute engine 240, 340 includes partial data memory 246, 346 that receives and stores the compute output generated by each sub-compute engine 244, 344.

In some implementations, the data is transferred from the local memory to the input memory with an input data bus for transferring input data and a weights bus for transferring weights, e.g., as illustrated in FIG. 2B with the input data bus 236 and the weights bus 234 and as illustrated in FIGS. 3B and 3C with the broadcast bus 332 and the weights data ring 334. In some implementations, the input data may be transferred via the weights bus and the weights may be transferred via the input data bus when the input data frame size is less than a predetermined number of bytes, such as discussed in reference to the dense mode.

In some implementations, the method may further include transferring the compute output from the partial data memory to the local memory with an output data bus, e.g., as illustrated in FIG. 2B with the output data bus 238 and as illustrated in FIG. 3C with the data ring 334. In some implementations, each slice further includes a descriptor execution engine and the compute output is transferred from the partial data memory to the local memory via the descriptor execution engine, and the method may further include performing at least one of activation and scaling functions with the descriptor execution engine to shape the compute output, e.g., as discussed in reference to the descriptor execution engine 232 illustrated in FIG. 2A and the descriptor execution engine 322 illustrated in FIG. 3A.

In some implementations, the method may further include accumulating compute outputs from each of the one or more sub-compute engines in the partial data memory. For example, as illustrated in FIGS. 2C and 3C, the partial data memory 246, 346 may accumulate the compute outputs.

In some implementations, the output data from each compute engine may be transferred to the system memory via the local memory and the system DMA engine, e.g., as illustrated in FIGS. 2A, 2C, and 3A.

In some implementations, transferring the data from the local memory to the input memory in the compute engine of each slice may include transferring the data to one a plurality of slices within each core, where each slice in the plurality of slices is independent of all other slices in the plurality of slices. For example, as illustrated in FIGS. 2A, 2B, 3A, 3B, and 3C, each core 220, 320 includes one or more slices 230, 330 that are independent of each other, and each slice 230, 330 and the data is transferred to each compute engine 240, 340 in each of the one or more slices 230, 330 within each core 220, 320.

In some implementations, each core may further include a compute sub-system, and the method may further include transferring the data from the local memory to the compute sub-system, and performing subroutines with the compute sub-system that are not performed in the one or more slices, e.g., as discussed in reference to the CSS 260 shown FIGS. 2A and 2D. The compute sub-system in each core, for example, may be a RISC-V microprocessor or the like.

In some implementations, the local memory may be double buffered, e.g., as discussed in reference to the local memory 224.

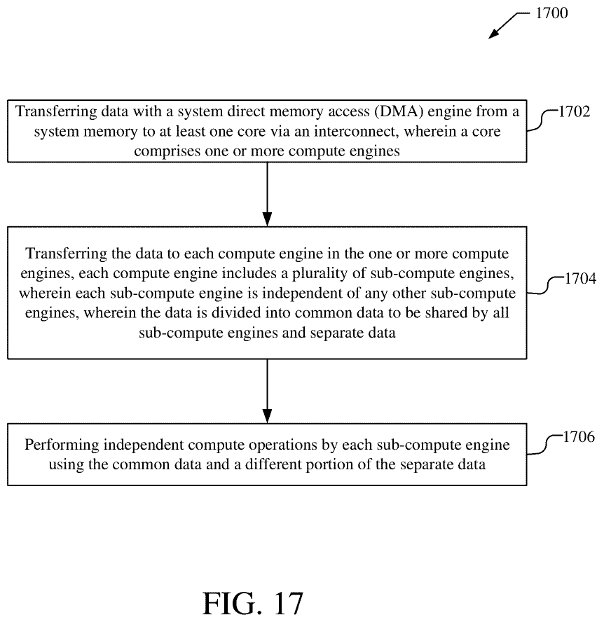

FIG. 17 shows an illustrative flowchart depicting an example operation 1700 for performing machine learning acceleration as discussed herein. In some implementations, the example operation 1700 may be performed using the machine learning acceleration system 200, shown in FIGS. 2A-2E, or the machine learning acceleration system 300 shown in FIGS. 3A, 3B, and 3C.

As illustrated, at block 1702, data is transferred with a system direct memory access (DMA) engine from a system memory to at least one core via an interconnect, where a core includes one or more compute engines. For example, as illustrated in FIGS. 2A, 2C, and FIG. 3A, the system DMA engine 210, 310 may provide a multiplexed direct communicative coupling between the system memory 204, 304 and each core 220, 320 via the interconnect 212, 312, which may have a desired topology such as a star, mesh, bus, tree, or ring.

At block 1704, the data is transferred to each compute engine in the one or more compute engines, each compute engine includes a plurality of sub-compute engines, where each sub-compute engine is independent of other sub-compute engines, where the data is divided into common data to be shared by all sub-compute engines and separate data. For example, as illustrated in FIGS. 2A, 2B, 3A, and 3C, the data is transferred to each compute engine 240, 340 that includes a plurality of sub-compute engines 244, 344, and, as discussed in reference to the various modes of operation, common data may be shared by all sub-compute engines.

At block 1706, compute operations are independently performed by each sub-compute engine using the common data and a different portion of the separate data. For example, as illustrated in FIGS. 2A, 2B, and 3C, each sub-compute engine 244, 344 independently performs a compute operation using the common data and a different portion of the separate data.

In some implementations, the method may further include receiving and storing in partial data memory in each compute engine a compute output from each of the plurality of sub-compute engines. In some implementations, the method may further include accumulating compute outputs from each of the plurality of sub-compute engines in the partial data memory. For example, as illustrated in FIGS. 2C and 3C, each compute engine 240, 340 includes partial data memory 246, 346 that receives and stores the compute output generated by each sub-compute engine 244, 344, and in some implementations, the partial data memory 246, 346 may accumulate the compute outputs.

In some implementations, the method may further include receiving the common data and the separate data by input data memory in each compute engine. The common data may be received via a broadcast bus and the separate data may be received via a data ring. Additionally, the output data from each compute engine may be transferred via the data ring. For example, as illustrated in FIGS. 2B, 3B and 3C, each compute engine 240, 340 includes input data memory 242, 342 receiving the common data and the separate data, e.g., by the input data bus 236 and the weights bus 234 respectively, shown in FIG. 2B, and the broadcast bus 332 and the data ring 334 respectively, shown in FIGS. 3B and 3C, and the output data from the compute engine 240 340 may be transferred via output data bus 238 in FIG. 2B or the data ring 334 in FIGS. 3B and 3C.

In some implementations, the data may be transferred to each compute engine in the one or more compute engines by transferring the data to one or more slices within each core, where each slice includes a different set of compute engines and slices are independent of each other. For example, as illustrated in FIGS. 2A 2B, 3A and 3B, each core 220, 320 includes one or more slices 230, 330 that are independent of each other, and each slice 230, 330 includes a different set of compute engines 240, 340 and the data is transferred to each compute engine 240, 340 in each of the one or more slices 230, 330 within each core 220, 320.

In some implementations, the method may further include receiving the data via the interconnect by local memory in a descriptor execution engine in each core, and executing descriptors in the data and sending the data to the one or more compute engines by the descriptor execution engine. The method may further include communicating with the system DMA engine and at least one other core via the interconnect by the descriptor execution engine. For example, as illustrated in FIG. 3A, each core 320 may include a descriptor execution engine 322 that includes local memory 324 and is configured to receive data via the interconnect 312 and to receive descriptors from the system DMA engine 310. The descriptor execution engine 322 is configured to execute the descriptors and to send data to the one or more compute engines 340.

In some implementations, the common data and the separate data include input data and weights, and the independent compute operations are performed by each sub-compute engine based on the input data and weights, e.g., as by the plurality of sub-compute engines 244, 344 illustrated in FIGS. 2A, 2B, 3A, and 3C, and discussed in reference to the various modes of operation. In some implementations, each compute engine may operate in at least one mode as described herein. For example, in one mode (Mode 0), the input data is the separate data and the weights are the common data and each sub-compute engine receives a different portion of the input data and same weights are received by each of the sub-compute engines, where the plurality of sub-compute engines is an output channel. In another mode (Mode 1), the input data is the common data and the weights are the separate data and each sub-compute engine receives same input data and different weights are received by each of the sub-compute engines, where each sub-compute engine is a different output channel. In another mode (Mode 2), the input data is the common data and the weights are the separate data and each compute engine is divided into groups of sub-compute engines, where each sub-compute engine receives same input data and different weights are received by each group of sub-compute engines, where each group of sub-compute engines is a separate output channel. In another mode (Mode 3), the input data and the weights is the separate data and each compute engine is divided into groups of sub-compute engines, where each group of sub-compute engines receives different input data and different weights, where each group of sub-compute engines is a separate output channel.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may include random access memory (RAM) such as synchronous dynamic random-access memory (SDRAM), read only memory (ROM), non-volatile random access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logical blocks, modules, circuits, and instructions described in connection with the implementations disclosed herein may be executed by one or more processors (or a processing system). The term “processor,” as used herein may refer to any general-purpose processor, special-purpose processor, conventional processor, controller, microcontroller, and/or state machine, any of which being capable of executing scripts or instructions of one or more software programs stored in memory that when executed cause it to perform one or more functions as described herein and to operate as a special-purpose processor. Unless specifically stated otherwise as apparent from the following discussions, it is appreciated that throughout the present application, discussions utilizing the terms such as “accessing,” “receiving,” “transmitting,” “transferring,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices. Further, the term “coupled” as used herein means connected directly to or connected through one or more intervening components or circuits. The terms “electronic system” and “electronic device” may be used interchangeably to refer to any system capable of electronically processing information.

In the foregoing specification, implementations have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. An apparatus configured for machine learning acceleration, the apparatus comprising:
a system direct memory access (DMA) engine communicatively coupled to a system memory; and
at least one core communicatively coupled to the system DMA engine via an interconnect, wherein the system DMA engine is configured to transfer data to local memory in the at least one core via the interconnect, each core comprising a one or more slices, wherein each slice comprises a compute engine, each compute engine comprises:
input data memory communicatively coupled to receive the data from the local memory;
one or more sub-compute engines, each sub-compute engine is separately communicatively coupled to the input data memory and is configured to perform a compute operation on the data stored in the input data memory; and
partial data memory communicatively coupled to receive and store a compute output from each of the one or more sub-compute engines.

2. The apparatus of claim 1, wherein each slice is coupled to receive the data from the local memory and is not directly connected to another slice.

3. The apparatus of claim 2, wherein each core further comprises a compute sub-system coupled to the local memory and that operates in parallel with the one or more slices.

4. The apparatus of claim 3, wherein the compute sub-system performs subroutines that are not performed in the one or more slices.

5. The apparatus of claim 1, wherein each slice further comprises a descriptor execution engine configured to execute descriptors and to receive the compute output from the partial data memory.

6. The apparatus of claim 5, wherein the descriptor execution engine is further configured to run at least one of activation functions and scaling functions on the compute output from the compute engine, and to operate on shaping the compute output and to send the compute output to the local memory.

7. The apparatus of claim 1, wherein the input data memory in each compute engine receives and stores the data via an input data bus for transferring input data and a weights bus for transferring weights, and wherein the partial data memory transfers the compute output via an output data bus.

8. The apparatus of claim 7, wherein the input data is transferred via the weights bus and the weights are transferred via the input data bus when an input data frame size is less than a predetermined number of bytes.

9. The apparatus of claim 1, wherein compute outputs from each of the one or more sub-compute engines are accumulated in the partial data memory.

10. A method for performing machine learning acceleration, the method comprising:
transferring data with a system direct memory access (DMA) engine from a system memory to local memory in at least one core via an interconnect, wherein each core comprises one or more slices, each slice comprising a compute engine;
transferring the data from the local memory to an input memory in the compute engine of each slice;
transferring the data from the input memory to one or more sub-compute engines, wherein each sub-compute engine is independent of other sub-compute engines;
performing independent compute operations on the data by each sub-compute engine; and
receiving and storing in partial data memory in the compute engine a compute output from each of the one or more sub-compute engines.

11. The method of claim 10, wherein the data is transferred from the local memory to the input memory with an input data bus for transferring input data and a weights bus for transferring weights.

12. The method of claim 11, wherein the input data is transferred via the weights bus and the weights are transferred via the input data bus when an input data frame size is less than a predetermined number of bytes.

13. The method of claim 10, further comprising transferring the compute output from the partial data memory to the local memory with an output data bus.

14. The method of claim 13, wherein each slice further comprises a descriptor execution engine and the compute output is transferred from the partial data memory to the local memory via the descriptor execution engine, the method further comprising performing at least one of activation and scaling functions with the descriptor execution engine to shape the compute output.

15. The method of claim 10, further comprising accumulating compute outputs from each of the one or more sub-compute engines in the partial data memory.

16. The method of claim 10, wherein output data from each compute engine is transferred to the system memory via the local memory and the system DMA engine.

17. The method of claim 10, wherein transferring the data from the local memory to the input memory in the compute engine of each slice comprises transferring the data to a plurality of slices within each core, wherein each slice in the plurality of slices is independent of all other slices in the plurality of slices.

18. The method of claim 10, wherein each core further comprises a compute sub-system, the method further comprising:
transferring the data from the local memory to the compute sub-system; and
performing subroutines with the compute sub-system that are not performed in the one or more slices.

19. The method of claim 18, wherein the compute sub-system in each core comprises a RISC-V microprocessor.

20. The method of claim 10, wherein the local memory is double buffered.
